(19) United States
(12) Patent Application Publication
(10) Pub. No.: US 2013/0002484 A1
(43) Pub. Date: Jan. 3, 2013

(54) INDOOR NAVIGATION WITH GNSS RECEIVERS

(75) Inventor: Daniel A. Katz, Kiryat Ono (IL)

(73) Assignee: Daniel A. Katz, Kiryat Ono (IL)

(21) Appl. No.: 13/175,855

(22) Filed: Jul. 3, 2011

(51) Int. Cl. G01S 19/11

(52) U.S. Cl. 342/357.48

(57) ABSTRACT

Global Navigation Satellite Systems (GNSS), such as the US GPS, the European GALILEO and the Russian GLONASS, are based on a mathematical concept known in the art as “three dimensional Trilateration”, where a point is determined by its distances from three other points. The point we wish to determine is the position of a GNSS receiver, typically located by the earth surface, in a car or onboard a ship or aircraft or carried by a person, while the other points are satellites orbiting around the earth. The distances between the satellites and the receiver are estimated by measuring the travelling time of signals transmitted from the satellites, at the speed of light, until arriving at the receiver. Typically, an unobstructed line of sight is required between GNSS satellites and the receiver, for a GNSS receiver to detect these signals and determine its position. Thus, a GNSS receiver located indoors, e.g. inside a concrete building, tunnel or basement, usually cannot determine its position based only on signals transmitted by the satellites. The present invention discloses a method for indoor navigation with GNSS receivers, based on or augmented by signals broadcast by local transmitters, also known as Pseudolites (“pseudo-satellites”). This task is not straightforward since GNSS receivers are designed to monitor satellites orbiting in space around the center of the earth, while pseudolites are typically deployed on the surface of the earth, thus continuously rotate around the earth axis, so unless placed on the equator, these pseudolites do not orbit around the center of the earth, so not easily can emulate GNSS satellites.

### BACKGROUND OF THE INVENTION

The present invention relates to the art of digital communications, particularly to radio navigation, and more precisely to satellite based radio navigation.

Global Navigation Satellite Systems (GNSS), such as the US GPS, the European GALILEO and the Russian GLONASS, are based on a mathematical concept known in the art as “three dimensional Trilateration”, where a point is determined by its distances from three other points. The point we wish to determine is the position of a GNSS receiver, typically located by the earth surface, in a car or onboard a ship or aircraft or carried by a person, while the other points are satellites orbiting around the earth. The distances between the satellites and the receiver are estimated by measuring the travelling time of signals transmitted from the satellites, at the speed of light, until arriving at the receiver. FIG. 1 depicts the GPS Trilateration Concept.

Theoretically, three distance measurements are required to resolve the three spatial coordinates (x, y, z) of the receiver. However, practically, four satellites are monitored by the receiver, in order to account also for the receiver's clock drift, compared to the accurate satellite constellation clock. Modern and precise receivers normally monitor even more than four satellites simultaneously, acquiring redundant data to refine the determination of self position by statistical methods.

The four basic GPS equations, referred in the art as the “navigation equations” or “range equations” or “pseudo range equations”, are represented as following:

PRᵢ−C*Δt_{SVi}=√[(x−xᵢ)²+(y−yᵢ)²+(z−zᵢ)²]+C*Δt_{R}; i=1−4 (1)

### Where:

PRᵢ=“Pseudo Range” between SVᵢ (Space Vehicle “i”) and the receiver
C=the speed of light, ˜300,000 Km/sec
Δt_{SVi}=SVᵢ clock deviation from “GPS Time” (the system reference time)
x, y, z=the receiver's position (initially unknown, to be calculated)
xᵢ, yᵢ, zᵢ=SVᵢ position
Δt_{R}=the receiver's clock drift from GPS Time.

As a person skilled in the art may appreciate, the part √[(x−xᵢ)²+(y−yᵢ)²+(z−zᵢ)²] expresses the geometrical distance between SVᵢ and the receiver, in Cartesian coordinates. This expression is actually the Pythagorean theorem in three dimensions.

On the other side of equation (1), PRᵢ also expresses the range between SVᵢ and the receiver, however as hinted by its name, PRᵢ is not the exact range but only an approximated range. In practice, PRᵢ is the travelling time between SVᵢ and the receiver, multiplied by the speed of light. It is called “Pseudo range” (and not “range”) since the travelling time of the signal is coarsely estimated as the difference between the time when the signal is detected, to the time when this signal was transmitted, however those two time measurements are performed by different clocks: the time of detection is determined according to the receiver's clock, while the time of transmission is determined by the satellite's clock and reported in the broadcast signal. Clearly, the difference between these two clocks, of the transmitter and the receiver, distinguishes between the real range to the pseudo range. This inaccuracy is treated in the navigation equations (1), by accounting for the difference between each of these clocks and a common, well known and accurate time scale administered by the GPS system, named “GPS Time”. For this reason, Δt_{SVi} which stands for the SVᵢ clock deviation from the “GPS Time”, and Δt_{R} which stands for the receiver's clock deviation from the same “GPS Time”, complement equations (1).

As a skilled person may appreciate, the navigation equations (1) reflect the relations among the locations of GPS satellites and the receiver, at a certain time instant, assuming that the signals arrived from various GPS satellites were transmitted simultaneously, up to Δt_{SVi}.

Likewise, the positions of satellites (xi, yᵢ, zᵢ) and the position of the receiver (x, y, z) in equations (1), are represented according to a common Cartesian coordinate system known in the art as ECEF (Earth Centered Earth Fixed).

The basic task of a typical GNSS receiver is to resolve the four equations (1), to determine the four unknowns: x, y, z and Δt_{R}. Yet prior to resolving equations (1), the receiver has to determine the “known parameters” in equations (1), i.e. PRᵢ, Δt_{SVi}, xᵢ, yᵢ, zᵢ. For this purpose, the receiver uses information comprised in the signals broadcast by the GPS satellites.

As a person skilled in the art probably knows, the signals broadcast by GPS satellite are basically comprised of one or more RF carriers, modulated by two types of data streams: Pseudo-Random-Noise (PRN) codes and the navigation message.

The PRN codes are pre-known series of data, cyclically transmitted by each satellite, used for synchronization and ranging purposes. GPS PRN codes are Gold codes, wherein different satellites are allocated with different codes. PRNs obtain sharp auto-correlation (i.e. correlation with same code shifted in time) and flat cross-correlation (i.e. correlation between different codes) properties. Since the receiver knows in advance exactly which satellite transmits which code, it generates a replica of this code, and a correlation between this replica and the received signal means that a specific satellite signal is detected, at a specific time instant.

The navigation message is a series of bits, organized in frames and sub frames, conveying navigational data to the receiver (and to control stations) for resolving the navigation equations (1). Among other data, the navigation message comprises information indicating the location of the GPS satellites, and information indicating the time instant when the signal was transmitted. The latter is used to determine the range, actually the pseudo-range (PR,), between a satellite (i) and the receiver.

PRᵢ is calculated as the travelling time between SVᵢ and the receiver, multiplied by the speed of light. The transmitter and the receiver agree upon a reference point, in the navigation message stream, for which the transmitter reports the transmission time. This point is the first bit of the subframe that follows the subframe where the transmission time is reported. When the receiver detects this bit, it records its own time, say t_{Ri}, then decodes the transmitted time reported by SVᵢ in the previous subframe, say t_{Ti}, and determines PRᵢ=C*(t_{Ri}−t_{Ti}). However, since the navigation message bits are transmitted at a relatively low rate, 50 bps for the GPS, their rise time is relatively long (due to filtering effects) so provide a poor resolution of the estimated receive time and consequently inaccurate PRᵢ. Typically, a rise time of 1% of the bit period, i.e. 0.2 ms, will provide a pseudo-range inaccuracy of 60 Kms, which is totally intolerable. In order to improve the resolution of the pseudo range determination, the PRN code, at a rate of 1.023 MHz (referring to the civilian Coarse Acquisition=C/A signal), is used. This code is simultaneously broadcast by all GPS satellites, synchronized with the navigation message bits, therefore, when the receiver's correlator detects a PRN code, it actually refines t_{Ri}, to a level of about 1% of the PRN bit period, i.e. to 10 ns, equivalent to 3 meters in pseudo range. PR determination accuracy is one of the significant factors that influence the position determination accuracy of a GPS receiver. Typically, at the beginning of 2011, the GPS C/A service provides position accuracy of about 10 meters.

Determining the precise satellite position (xᵢ, yᵢ, zᵢ) referring to the time for which the receiver's position is to be determined, is not straightforward. This is because a GPS satellite does not directly report its instantaneous position, rather do it indirectly, by broadcast parameters of a mathematical model that describes its orbit, from which its position (xᵢ, yᵢ, zᵢ) can be calculated, for any time instant.

These parameters, known in the art as the “Keplerian Elements” of the orbit, are based on Johannes Kepler's laws of planetary motion, determined about 400 years ago, since the orbit of an artificial satellite around the earth obeys the same physical laws as a natural planet orbiting around the sun, as studied by Kepler.

According to Kepler's 1^{st} law, GPS satellites obtain an elliptical orbit with the center of the earth at one of the ellipse foci (plural of focus). In order to determine this orbit, six Keplerian elements are typically used: 2 parameters that describe the orbit shape and size, 3 parameters that describe the orbit orientation in space, and 1 parameter to determine the momentary position of the satellite on its orbit at one specific time. These parameters, collectively known in the art as “ephemeris” (of a specific satellite), are repeatedly broadcast by each GPS satellite, as part of the navigation message, and updated every couple of hours or so.

The 6 Keplerian elements (parameters) that describe a GPS satellite orbit are:

Size and Shape of Orbit:
i. a=semi-major axis of the ellipse
ii. e=eccentricity of the ellipse

Orientation of the Orbital Plane in Space:
iii. i=inclination between the orbit plane and the earth equator
iv. Ω2=Right Ascension of Ascending Node (RAAN)=the Longitude (in spatial coordinates) of the ascending node of the orbit, specifying the angle from a reference direction, known as the First Point of Aries (Vernal Equinox), to the direction of the ascending node, measured from the earth center on the equatorial plane
v. ω=argument of perigee=angle from the ascending node to perigee (point of closest approach)

Position of the Satellite in the Orbital Plane:
vi. tₒₑ=epoch of perigee passage=time when satellite is at perigee

Basically, a GPS receiver detects the 6 Keplerian elements of each satellite that it tracks, and calculates in real time the instantaneous position of the satellite (xᵢ, yᵢ, zᵢ).

This process is done in two steps: first, the instantaneous position of the satellite on its own orbit is determined; then, this position is transformed to a Cartesian coordinate system, known as ECEF (Earth Centered Earth Fixed), which serves as the common coordinate system to GPS satellites and receivers.

The instantaneous position of the satellite on its orbital plane, in polar coordinates where the earth center is at the origin, is defined by:
r=the range between the earth center and the satellite; and
TA (True Anomaly)=the angle between the perigee and the satellite.

For satellites that move on a circular orbit (a special case of an elliptical orbit, where e=0), the angular speed is constant (according to Kepler's 2^{nd} law), and can be directly computed from the orbit radius, so TA changes linearly with time, and once an initial TA(t=T₀) is known, e.g. the satellite been at perigee at T₀, then it is easy to calculate TA(t) for any time.

However, on a general elliptical orbit (where e≠0) as is the case with GPS satellites, a satellite does not obtain a constant angular speed (according to Kepler's 2^{nd} and 3^{rd} laws), so it is not trivial to extrapolate its TA(t). Thus, two additional angles are defined on the orbit, as auxiliary parameters for computing TA(t): Mean anomaly=M(t), and Eccentric anomaly=E(t). Kepler already showed how can TA(t) be computed from E(t), and E(t) computed from M(t). So, accordingly, GPS satellites broadcast, in the navigation message, data to calculate M(t), which the receiver uses to calculate E(t) and in turn calculate TA(t). Similarly, the receiver can calculate r(t).

The geometrical relations between said orbital polar parameters are:

M(t)=M₀+n(t−tₒₑ) (2)

E(t)=M(t)+e sin E(t), also known as Kepler's equation. (3)

TA(t)=arc tan {[(1−e²)^{(1/2)}*sin E(t)]/[cos E(t)−e]} (4)

r(t)=a[1−e cos E(t)] (5)

### Where:

M(t)=mean anomaly (as a function of time)
t=time
tₒₑ=reference time for ephemeris parameters (perigee passage)
M₀=mean anomaly at reference time tₒₑ
n=√(GM_{E}/a³)=2π/P=average angular speed
E(t)=Eccentric anomaly
P=full orbit revolution Period
GM_{E}=Newton's Gravitational constant*the earth mass (=3.986005×10¹⁴ m³/s²)
a=semi major axis of the orbit's ellipse
e=eccentricity of the orbit's ellipse
r=range between SV and earth center

As well known in the art, for GPS satellites:
a=a_{Gps}=26,559,800 meters
P=11 h58 min (=half a sidereal day)

Obviously, equations (2)-(5) apply not only to GPS satellites, but also to other type of satellites, such as Geostationary (GEO) satellites. For GEO satellites, for example:
P=1 sidereal day=86,164.1 sec
n_{GEO}=2π/P=2π/86,164.1 s=7.292115 E−5 1/s
a_{GEO}=[GM_{E}/(n_{GEO})²]^{1/3}=[3.986005×10¹⁴ m³/(7.292115 E−5)²]^{1/3}=42,164,167 m

The polar orbital position parameters r(t) and TA(t) of a satellite, may be transformed to Cartesian coordinates, still in the orbital plane: r*cos TA, r*sin TA and 0.

Then, prior to resolving equations (1), the satellite coordinates [r*cos TA, r*sin TA, 0] are transformed to ECEF coordinates (xᵢ, yᵢ, zᵢ), by the three rotations: R_{z}(−Ω)Rₓ(−i)R_{z}(−ω), as following:

$$\vert \begin{matrix}{x}_{i} \\ {y}_{i} \\ zi\end{matrix} \vert = \vert \begin{matrix}cos Ω & - sin Ω & 0 \\ sin Ω & cos Ω & 0 \\ 0 & 0 & 1\end{matrix} \vert \times \vert \begin{matrix}1 & 0 & 0 \\ 0 & cos i & - sin i \\ 0 & sin i & cos i\end{matrix} \vert \times \vert \begin{matrix}cos ω & - sin ω & 0 \\ sin ω & cos ω & 0 \\ 0 & 0 & 1\end{matrix} \vert \times \vert \begin{matrix}r cos TA \\ r sin TA \\ 0\end{matrix} \vert$$

resulting with:

$$\vert \begin{matrix}{x}_{i} \\ {y}_{i} \\ {z}_{i}\end{matrix} \vert = \vert \begin{matrix}r cos ( TA + ω ) cos Ω - r sin ( TA + ω ) sin Ω cos i \\ r cos ( TA + ω ) sin Ω + r sin ( TA + ω ) cos Ω cos i \\ r sin ( TA + ω ) sin i\end{matrix} \vert \qquad ( 6 )$$

In practice, the satellite orbit is more complex than as described by the simple Keplerian model, due to Perturbations caused by gravitational effects from celestial massive bodies beyond the earth (e.g. the sun and the moon), and other effects as the earth flattened shape, occasional satellite acceleration, etc. Thus, the exact orbit of each satellite is constantly monitored by control stations on the earth, which govern the navigation message that the satellites broadcast, so in time, each satellite broadcast also parameters that correct its Keplerian orbit, as uploaded by the control stations on earth. A GPS receiver employs then a more complex algorithm that accounts also for these corrections.

So, the arguments in equation (6) are further refined using corrective data comprised in the navigation message: argument of latitude (TA+ω), range (r), RAAN (Ω) and inclination (i), as following.
(TA+ω)ₖ=the Argument of Latitude at the time of tₖ seconds after tₒₑ, is further corrected to uₖ:

uₖ=Φₖ+Cᵤₛ sin(2Φₖ)+C_{uc} cos(2Φₖ); (7)

### Wherein:

Φₖ=(TA+ω)ₖ
Cᵤₛ=Amplitude of the Sine Harmonic Correction Term to the Argument of Latitude
C_{uc}=Amplitude of the Cosine Harmonic Correction Term to the Argument of Latitude
rₖ=the range between the satellite and the earth center (at tₖ+tₒₑ), basically defined in equation (5), is further corrected as following:

rₖ=a[1−e cos E(t)]+Cᵣₛ sin(2Φₖ)+C_{rc} cos(2Φₖ) (8)

### Wherein:

Cᵣₛ=Amplitude of the Sine Harmonic Correction Term to the Orbit Radius
C_{rc}=Amplitude of the Cosine Harmonic Correction Term to the Orbit Radius

Ω^{k}=the Right Ascension of Ascending Node (RAAN) at tₖ+tₒₑ is:

Ωₖ =Ω₀+(Ω′−Ω′_{E})(t−tₒₑ)−Ω′_{E}*tₒₑ (9)

### Wherein:

Ω′_{E}=the earth rotation rate=7.2921151467 E−5 rad/s.
t=GPS time at time of transmission=tₖ+tₒₑ
Ω₀=RAAN at weekly epoch (start of the present GPS week)
Ω′=change rate of RAAN
tₒₑ=reference time of the ephemeris parameters
iₖ=the inclination between the orbital plane and the equatorial plane (at tₖ+tₒₑ), is:

iₖ=i₀+i′(t−tₒₑ)+Cᵢₛ sin(2Φₖ)+C_{ic} cos(2Φₖ) (10)

### Wherein:

i₀=inclination angle at the ephemeris reference time
i′=rate of inclination angle
tₒₑ=reference time of the ephemeris parameters
Cᵢₛ=Amplitude of the Sine Harmonic Correction Term to the Angle of Inclination
C_{ic}=Amplitude of the Cosine Harmonic Correction Term to the Angle of Inclination

The corrected ECEF position of satellite i at the time t=tₖ+tₒₑ is therefore:

$$\vert \begin{matrix}{x}_{i} \\ {y}_{i} \\ {z}_{i}\end{matrix} \vert = \vert \begin{matrix}{r}_{k} cos ( {u}_{k} ) cos {Ω}_{k} - {r}_{k} sin ( {u}_{k} ) sin {Ω}_{k} cos {i}_{k} \\ {r}_{k} cos ( {u}_{k} ) sin {Ω}_{k} + {r}_{k} sin ( {u}_{k} ) cos {Ω}_{k} cos {i}_{k} \\ {r}_{k} sin ( {u}_{k} ) sin {i}_{k}\end{matrix} \vert \qquad ( 11 )$$

where: uₖ, rₖ, Ωₖ and iₖ are calculated according to equations (7), (8), (9) and (10),
and wherein the following parameters are broadcast by each satellite in the ephemeris part of the navigation message: a, e, Cᵣₛ, C_{rc}, ω, Cᵤₛ, C_{uc}, M₀, Ω₀, Ω′, Ω′_{E}, tₒₑ, i₀, i′, Cᵢₛ, C_{ic},
wherein: GM_{E}=3.986005×10¹⁴ m³/s², Ω′_{E}=7.2921151467 E−5 rad/s.

As a person skilled in the art probably knows, additional corrections may further refine some of the arguments that influence equation (11). These include the rate change of the semi-major axis (a), and the rate change of mean motion (n), as following.

aₖ=a₀+a′tₖ (12)

where:
a₀=semi-major axis at reference time
a′=Change rate in semi-major axis
   and,

nₐ=n₀+Δnₐ (13)

where:
n₀=computed value of mean motion=√[GM_{E}/(a₀)³]
Δnₐ=Δn₀+½(Δn₀)′tₖ
Δn₀=mean motion difference from computed value at reference time
(Δn₀)′=rate of mean motion difference from computed value
   then, equation (2) is refined to:

Mₖ=M₀+nₐ*tₖ ; where tₖ=t−tₒₑ

The above equations (2)-(13) are well covered in the GPS Interface Specification (IS) documents, and in the GPS Interface Control Documents (ICD), published by US authorities.

These documents may be accessed via http://www.gps.gov/technical/icwg/, a site that provides the Official U.S. Government information about the Global Positioning System (GPS) and related topics.

Both, IS-GPS-200E and IS-GPS-800A, dated 8 Jun. 2010, are references to the present invention.

At this point, upon calculating the ECEF coordinates (xᵢ, yᵢ, zᵢ) of 4 satellites, the receiver can basically resolve the 4 navigation equations (1), assuming that it already determined PRᵢ and Δt_{SVi}, for these same satellites.

However, satellite navigation systems such as GPS, GALILEO and GLONASS, are designed to operate in open spaces, where there is substantially a line of site between the receiver and the satellites. This nature of GNSSs is related to the relatively high frequency of the carrier of the signal broadcast by the satellites, typically in the L band. Therefore, the satellite signals can be hardly detected indoors.

In order to navigate with a GNSS receiver indoors, the present art suggests deploying an infrastructure of local transmitters that relay or replace the satellite signals. Such local transmitters are known in the art as “Pseudolites” (“pseudo-satellites”), i.e. (from Wikipedia:) “something that is not a satellite which performs a function commonly in the domain of satellites. Pseudolites are most often small transceivers that are used to create a local, ground-based GPS alternative. The range of each transceiver's signal is dependent on the power available to the unit. Being able to deploy one's own positioning system, independent of the GPS, can be useful in situations where the normal GPS signals are either blocked/jammed (military conflicts), or simply not available (exploration of other planets). Other applications of pseudolite arrays include precision approach landing systems for aircraft and highly accurate tracking of transponders.

Pseudolites have started to gain more and more attention in the context of indoor location”.

Yet, as discussed above, the algorithm employed by standard GNSS receivers assumes that the detected signals come from transmitters that orbit around the earth on elliptical orbits with the center of the earth on one of the ellipse foci, and accordingly interprets the navigation message comprised in said signals. However, differently to GNSS satellites, pseudolites placed on the surface of the earth do not orbit around the center of the earth (unless placed on the equator), but just around the axis of the earth, at a constant latitude above the equator.

Furthermore, the algorithm employed by GNSS receivers assumes Keplerian orbits for the satellites, so expects a certain relation between the semi-major axis (a) of the orbit and the revolution period (P) of a transmitter on this orbit, explicitly: P=2π/√(GM_{E}/a³). Yet, the movement in space of a pseudolite placed on the surface of the earth does not obey this equation. Such a pseudolite obtains a revolution period (P) of a sidereal day, and orbit radius (i.e. semi major axis of circular ellipse) not larger than the radius of the earth (˜6371 km). But as a person skilled in the art may appreciate, a satellite that orbits around the earth in a day period is a geostationary satellite, typically at a radius of 42,164 Km from the earth center.

Therefore, it is an object of the present invention to enable GPS receivers to determine self position in places where the satellite signals are partially present or not present at all.

It is another object of the present invention to enable GPS receivers to determine self position using signals broadcast by pseudolites deployed on the surface of the earth.

The present art discloses different methods for employing pseudolites, and particularly to broadcast the pseudolite position. For example, Trautenberg, Hans Ludwig, U.S. Pat. No. 7,508,341, discloses “a method for transmission of navigation data to user terminals of a satellite navigation system composed of navigation satellites and pseudolites . . . wherein the positional information is transmitted in the form of a model of a pseudolite trajectory in a reference coordinate system which the model accounts for orbit-divergent motions . . . ”, yet “the model does not include, by itself, the relevant path for the trajectory of the pseudolites 2 in the form of Keplerian orbit models . . . ” (column 10 lines 41-53).

It is then an object of the present invention to enable GPS receivers to determine self position, at a reasonable accuracy, using pseudolite signals that broadcast standard GPS signals, i.e. signals that comply with the GPS Interface Specification (IS) or GPS Interface Control Document (ICD).

It is also an object of the present invention to represent the movement in space of pseudolites placed on the surface of the earth, using a Keplerian model of orbiting around the center of the earth, although the pseudolites actually do not orbit around the center of the earth.

U.S. Pat. No. 5,886,665 to Dosh, et al. discloses pseudolite systems wherein “the 50 Hz navigational data must be adapted to reflect the fact that the pseudo-satellite 12 is stationary. Dummy values may be used for the six Keplerian orbit parameter terms, with values chosen to produce a result in three-dimensional space consistent with the actual location and velocity of the pseudo-satellite 12” (column 3 lines 42-48), however, does not disclose the configuration of these six Keplerian orbit parameters.

It is still an object of the present invention to represent the position in space of pseudolites placed on the surface of the earth, on Keplerian orbits with typically fixed orientation in space, although the pseudolites actually rotate around the axis of the earth, and wherein the imaginary instantaneous position of the pseudolite on its imaginary orbit is constant in time.

Other methods disclosed by the present art include modifications of a GPS receiver, in order to determine self position by signals broadcast by pseudolite. For example, U.S. Pat. No. 5,886,666 by Schellenberg , et al. discloses “Receiver 150 preferably has the Keplerian equations modified to remove the time varying constants format of the equations” (column 4 lines 50-54).

So it is yet another object of the present invention to enable GPS receivers to determine self position, at a reasonable accuracy, using pseudolite signals that broadcast reference signals, employing a similar algorithm as applied for real satellite signals.

About Terminology

In the art, as well as in this document, different terms are sometimes used to describe the same object; in other occasions, similar terms are used to describe different objects; yet, as a person skilled in the art may appreciate, this does not have to prevent a correct interpretation of the present invention, as long as the context is well determined.

To illustrate, and without limiting said general argument, some examples are:
a. GNSS is a general term for Global Navigation Satellite Systems, while some special cases of GNSS are: the US GPS (Global Positioning System), the European GALILEO and the Russian GLONASS. Yet, “GPS” is typically used instead of “GNSS”, and vice versa.
b. “SPS” (Satellite Positioning System) and “SNS” (Satellite Navigation System) are also acronyms to “GPS” and “GNSS”.
c. Sometimes, just “GPS” is used instead of “GPS receiver” or “GNSS receiver”.
d. “SV” means Space Vehicle, or satellite, or more precisely an artificial satellite.
e. Communication or navigation satellites are typically installed with payloads comprising transmitters and/or receivers. Nevertheless, it is common to say that satellites “transmit” or “receive”, instead of referring to the transmitter or receiver onboard the satellite.
f.“anomalies” or “arguments” are equivalent terms to angles.
g. The range between a satellite and a GPS receiver is sometimes called “pseudo range” (“PR”), and vice versa.
h. GPS/GNSS are based on a mathematical method called “Trilateration” (similar to triangulation), since the basic method is based on measuring three distances; however, in many cases, four or even more such distances are measured, still calling that method “Trilateration” (or “triangulation”).
i. The three or four (or more) basic GPS equations are referred to as the “navigation” or “range” or “pseudo range” equations.
j. GPS/GNSS are based on a communication method called Direct Sequence Spread Spectrum (DSSS), also referred as Code Domain Multiple Access (CDMA). In this context, the digital code that modulates, or “spreads” the carrier signal, is called a “spreading sequence”, or “Pseudo Random Noise” (PRN) sequence or “ranging code”.
k. Usually, in satellite based navigation systems, the satellites transmit signals which a remote user device detects to determine its position. Yet, in some satellite based navigation systems, typically known as “location systems”, the remote user device transmits signals which the satellites receive and employ to calculate the remote device location. In this context, GPS, GLONASS and GALILEO are examples to “navigation systems”, while Cospas-Sarsat and ARGOS are “location systems”. Nonetheless, the present invention is relevant and applicable to both “navigation systems” and “locations systems”.

### REFERENCES

IS-GPS-200E 8 Jun. 2010
GLOBAL POSITIONING SYSTEM WING (GPSW)
SYSTEMS ENGINEERING & INTEGRATION
INTERFACE SPECIFICATION
IS-GPS-200 Revision E
Naystar GPS Space Segment/Navigation User Interfaces
IS-GPS-800A 8 Jun. 2010
GLOBAL POSITIONING SYSTEM WING (GPSW)
SYSTEMS ENGINEERING & INTEGRATION
INTERFACE SPECIFICATION
IS-GPS-800 Revision A
Naystar GPS Space Segment/User Segment L1C Interface

Other objects and advantages of the invention will become apparent as the description proceeds.

### SUMMARY OF THE INVENTION

The invention is directed to a method for determining the position of a Global Navigation Satellite System (GNSS) receiver, by broadcasting reference signals from at least one transmitter substantially stationary in reference to the surface of the earth, comprising the steps of:

a) configuring said reference signals to:
(i) specify an imaginary orbit in space on which said transmitter is reported to be, said orbit based on an ellipse, one of said ellipse foci at the center of the earth, and at least one point on said orbit substantially stationary in reference to the surface of the earth;
(ii) indicate the position of said transmitter substantially at said stationary point; and,
   b) configuring said receiver to detect said reference signals, and:
(i) calculate the momentarily position of said transmitter on said imaginary orbit in space;
(ii) estimate the distance to said momentarily position;
(iii) determine self position, upon calculating the position of and estimating the distance to typically four transmitters.

Said imaginary elliptical orbit with the center of the earth on one of the ellipse foci, is a Keplerian orbit, on which GPS satellites typically move. Such orbits basically obtain a fixed orientation in space, typically defined by three angles: ω (argument of perigee), Ω (RAAN), and i (inclination), as detailed in the BACKGROUND OF THE INVENTION.

Yet, a pseudolite placed on the surface of the earth moves on a different type of orbit in space: a circle, around the axis of the earth, at specific latitude above the equator.

A GPS receiver determines its self position based on the position of GPS satellites, using their broadcast orbital representation. But the actual movement in space of a pseudolite placed on the surface of the earth cannot be represented by a Keplerian model, as expected by GPS receivers.

So, the basic strategy disclosed by the present invention is to broadcast “faked” Keplerian parameters, by pseudolites that “pretend” being on orbit around the center of the earth, still indicating a stationary “satellite” position, in reference to the earth surface, i.e. keeping a fixed relation in space between the reported position of the transmitter, and its actual position. Preferably, the pseudolite broadcast reports a position identical to its actual position, however even if it is actually false, it can still serve to determine the receiver's position, up to a tolerable error, as long as it is stationary in reference to the earth surface.

The present invention discloses several ways which either alone, or in combination, represent a stationary position of a pseudolite, on the earth surface, using the Keplerian orbit model, by specifying:
a) semi-major axis of said ellipse equal to zero, or to the distance between the center of the earth and a specific point on the earth surface, or to the geostationary radius;
b) eccentricity of said ellipse equal to zero;
c) inclination between said orbit and the earth equator equal to zero, or to ninety degrees;
d) rotation speed of said orbit around the earth axis equal to zero, or to the earth rotation speed, or to the earth rotation speed plus or minus the angular speed on an equatorial orbit due to the earth gravitational force;
e) corrected argument of latitude of said transmitter on its orbit substantially constant in time;
f) corrected mean motion of said transmitter on its orbit equal to zero.

The most basic stationary Keplerian orbit is a singular point right on the center of the earth, specified by the semi-major axis of the orbit ellipse equal to zero. This method emulates a satellite stationary at the center of the earth.

Specifying the semi-major axis of the orbit ellipse equal to the geostationary radius, in combination with a zero inclination, emulates a satellite on a geostationary orbit.

Specifying the semi-major axis of the orbit ellipse equal to the distance between the center of the earth and a specific point on the earth surface, emulates a satellite orbiting by the surface of the earth. If said specific point on the earth surface is the actual position of the pseudolite, then at least one point in space, is common to the represented satellite orbit and to the actual orbit of the pseudolite.

Specifying the ellipse eccentricity equal to zero defines a circular orbit, which is easier to manipulate, particularly useful when configuring the pseudolite parameters, for a specific location installation.

Specifying the inclination between said orbit and the earth equator equal to zero is useful to define a geostationary orbit for the pseudolite.

Specifying a ninety degrees inclination defines a polar orbit, which may be further configured to be exactly on the longitude where the pseudolite is actually located.

Specifying the rotation speed of said orbit around the earth axis equal to the earth rotation speed, is an efficient way to “attach” the Keplerian orbit to the earth, both rotating at the same angular speed and around the same axis, so if further “freezing” the represented movement of the satellite on orbit, either by “freezing” the corrected argument of latitude of the emulated satellite, or configuring its corrected mean motion equal to zero, then the broadcast signal could represent exactly the actual position of the pseudolite.

Specifying the rotation speed of said orbit around the earth axis equal to the earth rotation speed plus or minus the angular speed on an equatorial orbit due to the earth gravitational force is useful when defining an imaginary geostationary orbit for the pseudolite.

The present invention discloses also specifying a rotation speed of said orbit around the earth axis equal to the earth rotation speed, and configuring at least one of:
a) the corrected argument of latitude of said transmitter substantially constant in time;
b) the corrected mean motion of said transmitter equal to zero;
   and indicating the position of said transmitter at one specific time instant, equal to the actual position of said transmitter.

Specifying the rotation speed of said orbit around the earth axis equal to the earth rotation speed, is a way to “attach” the Keplerian orbit to the earth, both rotating at the same angular speed and around the same axis. In addition, “freezing” either the corrected argument of latitude, or the corrected mean motion, “freezes” the momentarily position of the transmitter on its orbit, and since the orbit is also configured stationary in reference to the earth surface, so is the transmitter.

Furthermore, as discussed in the BACKGROUND OF THE INVENTION, the GPS signal broadcast by the satellites reports one reference position of the satellite, from which the momentarily position of the satellite can be extrapolated for any time, using Kepler's equations, so configuring this initial position, equal to the actual position of the pseudolite, in addition to “freezing” the orbit rotation and “freezing” the “satellite” movement on its orbit, ensures that the reported position of the pseudolite will stay aligned with its actual position, as time changes.

The present invention discloses also specifying a circular polar orbit, stationary over the longitude on which said transmitter is actually located, said orbit radius equal to the distance between the earth center and the actual position of said transmitter, and the corrected argument of latitude of said transmitter equal to the latitude on which said transmitter is actually located.

A circular orbit is specified by an ellipse with zero eccentricity (e), so the orbit radius is equal to the semi-major axis (a) of said ellipse, and a polar orbit is specified by inclination (i) of 90°. The orbit is stationary if rotating exactly at the earth rotation speed, i.e. specifying Ω′=Ω′_{E}, and the longitude over which this orbit is placed can be determined using equation (9).

The corrected argument of latitude of a satellite (i.e. pseudolite) on this orbit can be configured to be fixed in time, according to equation (7), in addition to equations (2), (3) and (4), as following. As e=0, TA(t)=E(t)=M(t)=M₀+n(t−tₒₑ), so setting the average angular speed (n) of said satellite to zero, will result with constant TA thus constant Φₖ and constant uₖ. Alternatively, manipulating the Amplitude of the Sine/Cosine Harmonic Correction Terms to the Argument of Latitude (Cᵤₛ and C_{uc}) may also achieve a corrected argument of latitude constant in time, easily configurable to the latitude on which said transmitter is actually located.

The present invention discloses also manipulating the transmission time instant as well as the indication of transmission time instant represented in the reference signals broadcast by the pseudolite, configuring at least one of: the actual transmission time instant or the reported transmission time instant of said reference signals, to at least one of:
a) the actual transmission time of other reference signals;
b) the reported transmission time of other reference signals;
c) the actual transmission time of other reference signals corrected according to the actual position of said transmitter and to the reported position of said transmitter;
d) the reported transmission time of other reference signals corrected according to the actual position of said transmitter and to the reported position of said transmitter.

As detailed in the BACKGROUND OF THE INVENTION, a GNSS receiver employs a mathematical method called “Trilateration”, wherein the distance between the receiver and each satellite is estimated measuring the time of a signal travelling between the satellite and the receiver, multiplied by the speed of light. This travelling time is measured using the transmission time instant indicated by the transmitter. Moreover, as a skilled person may appreciate, the GPS Trilateration method assumes that all the satellites transmit simultaneously, i.e. all satellites transmit at the same time the first bit of the navigation message and the first chip of the PRN sequence, all synchronized to one accurate time scale called “GPS time”, up to a slight deviation per satellite, named Δt_{SVi}, which is reported and accounted for in equation (1). In fact, each satellite comprises several accurate atomic clocks, to generate accurate signal frequency and timing, but a more accurate system clock, the “GPS time”, is administered on the ground, by the GPS control stations, which also monitor the deviation of each satellite clock from the common GPS time, upload these corrections, which are then broadcast by each satellite.

The Trilateration method employed by the GPS requires all the satellites to transmit simultaneously in order to “freeze” a spatial position of satellites, at a certain time, for which the navigation equations (1) are resolved. Yet, since the pseudolites according to the present invention are stationary, whenever the time is “frozen”, and whenever a snapshot of pseudolites is taken, the pseudolites are always at the same position, so strict time synchronization of transmission time of pseudolites is not a must.

Still, it is advised to configure the pseudolite transmission time so that the signals used by the receiver to resolve equation (1) will arrive at the receiver not too far (in time) from each other, particularly if satellite signals and pseudolite signals are used together.

The reported time of transmission, however, is essential for resolving the navigation equations (1) correctly. Preferably, according to the present invention, four or more pseudolites are deployed in a certain location and broadcast reference signals, each pseudolite reporting a position identical to its actual position, and all pseudolites reporting the same transmission time.

As a person skilled in the art may appreciate, the GPS may tolerate a non accurate receiver clock, as long as the clocks that govern the broadcast signals are accurate and synchronized with each other. This inaccuracy, i.e. the deviation of the receiver clock from GPS time, assigned Δt_{R}, is one of the four unknowns to be resolved from the four equations (i=1−4) represented by equation (1), in addition to the receiver coordinates (x, y, z). However, this is based on the assumption that all the satellites are synchronized to one master clock, reporting their transmission time and indicating their specific clock deviation from that master clock.

So, if a hybrid system of pseudolites and real satellites is considered, then the GPS time reference should preferably be used also by the pseudolites, generating the navigation message data determining the phase of PRN codes.

Further, pseudolite time reports may be refined, considering also the actual position and the reported position of the pseudolite.

For example, if a pseudolite is deployed at point “a”, however reports being at point “b”, then it makes sense also reporting a time of transmission as if the signal was transmitted from point “b”, i.e. subtract the time it would have taken the signal to travel from “b” to “a” at the speed of light, from the time measured when the signal is actually transmitted from point “a”.

One way to implement that is to indicate a constant clock delay at the pseudolite, i.e. report a clock deviation (according to equation 1) of: Δt_{SVi}=−(distance between “a” and “b”)/C.

The present invention discloses also deploying two or more pseudolites, either at different points or substantially at the same point.

Deploying several pseudolites at the same point is particularly useful in a location where a single point is sufficient to define the location, for a certain application. For example, four pseudolites are installed jointly, at a specific point in a store, configured to report their actual position and actual time.

Obviously, as a person skilled in the art may appreciate, placing all the pseudolites together provides a very poor geometry, i.e. high dilution of precision, however if the user is indifferent to the position accuracy within the store, as long as he/she determines being at the store, then the installation of pseudolites in this store becomes very simple.

The present invention discloses also configuring the pseudolite signals for pseudo random noise modulation, by at least one of:
a) a spreading sequence which is not employed by GNSS satellites in the area where said transmitter is deployed;
b) two or more different spreading sequences.

As a person skilled in the art may appreciate, the GPS satellite signal is typically modulated by two different sub-signals: a stream of variant data, namely the navigation message, and a pre-known cyclic series of bits named pseudo random noise (PRN) code. Each satellite is allocated with a specific PRN code, but extra codes were defined by the GPS authorities, for several functions, such as Wide Area Augmentation Systems (WAAS), also known as Satellite Based Augmentation Systems (SBAS). Such SBAS typically covers a restricted area, such as the USA or JAPAN. Configuring a pseudolite to a PRN not employed by GPS satellites in the area where this pseudolite is deployed, reduces the chance for interference with transmissions from real satellites.

Configuring a pseudolite to broadcast two or more PRN codes may be used to emulate more than one satellite by a single pseudolite.

The invention is further directed to a device, a radio transmitter, for determining the position of a Global Navigation Satellite System (GNSS) receiver, by broadcasting reference signals from said transmitter, said transmitter substantially stationary in reference to the surface of the earth, wherein said reference signals configured to:
(i) specify an imaginary orbit in space on which said transmitter is reported to be, said orbit based on an ellipse, one of said ellipse foci at the center of the earth, and at least one point on said orbit substantially stationary in reference to the surface of the earth;
(ii) indicate the position of said transmitter substantially at said stationary point; and said receiver configured to detect said reference signals, and:
(i) calculate the momentarily position of said transmitter on said imaginary orbit in space;
(ii) estimate the distance to said momentarily position;
(iii) determine self position, upon calculating the position of and estimating the distance to typically four transmitters.

Said imaginary orbit reported by said transmitter configured to specify at least one of:
a) semi-major axis of said ellipse equal to zero, or to the distance between the center of the earth and a specific point on the earth surface, or to the geostationary radius;
b) eccentricity of said ellipse equal to zero;
c) inclination between said orbit and the earth equator equal to zero, or to ninety degrees;
d) rotation speed of said orbit around the earth axis equal to zero, or to the earth rotation speed, or to the earth rotation speed plus or minus the angular speed on an equatorial orbit due to the earth gravitational force;
e) corrected argument of latitude of said transmitter on its orbit substantially constant in time;
f) corrected mean motion of said transmitter on its orbit equal to zero.

In said transmitter, said orbit rotation speed around the earth axis configured equal to the earth rotation speed, and at least one of:
a) the corrected argument of latitude of said transmitter configured substantially constant in time;
b) the corrected mean motion of said transmitter configured equal to zero;
   wherein the position of said transmitter at one specific time instant configured equal to the actual position of said transmitter.

Said reported orbit configured polar and circular, stationary over the longitude on which said transmitter is actually located, said orbit radius equal to the distance between the earth center and the actual position of said transmitter, and the corrected argument of latitude of said transmitter equal to the latitude on which said transmitter is actually located.

In said disclosed transmitter, at least one of: the actual transmission time instant or the reported transmission time instant of said reference signals, is configured to, at least one of:
a) the actual transmission time of other reference signals;
b) the reported transmission time of other reference signals;
c) the actual transmission time of other reference signals corrected according to the actual position of said transmitter and to the reported position of said transmitter;
d) the reported transmission time of other reference signals corrected according to the actual position of said transmitter and to the reported position of said transmitter.

Said transmitter configured for pseudo random noise modulation, by at least one of:
a) a spreading sequence which is not employed by GNSS satellites in the area where said transmitter is deployed;
b) two or more different spreading sequences.

Said transmitter attached to a directional antenna, configured to point its main lobe of transmission substantially along the line between the actual position of said transmitter and the position of the transmitter as indicated by said reference signals.

The invention is directed to another device, a Global Navigation Satellite System (GNSS) receiver, for determining self position by detecting reference signals broadcast by at least one transmitter specifying an imaginary orbit in space on which said transmitter is reported to be, said orbit based on an ellipse, one of said ellipse foci at the center of the earth, and at least one point on said orbit substantially stationary in reference to the surface of the earth, said reference signals indicating the position of said transmitter substantially at said stationary point, wherein said receiver configured to detect said reference signals and:
(i) calculate the momentarily position of said transmitter on said imaginary orbit in space;
(ii) estimate the distance to said momentarily position;
(iii) determine self position, upon calculating the position of and estimating the distance to typically four transmitters.

Said GNSS receiver, wherein said imaginary orbit specifying at least one of:
a) semi-major axis of said ellipse equal to zero, or to the distance between the center of the earth and a specific point on the earth surface, or to the geostationary radius;
b) eccentricity of said ellipse equal to zero;
c) inclination between said orbit and the earth equator equal to zero, or to ninety degrees;
d) rotation speed of said orbit around the earth axis equal to zero, or to the earth rotation speed, or to the earth rotation speed plus or minus the angular speed on an equatorial orbit due to the earth gravitational force;
e) corrected argument of latitude of said transmitter on its orbit substantially constant in time;
f) corrected mean motion of said transmitter on its orbit equal to zero.

Said GNSS receiver, said orbit rotation speed around the earth axis configured equal to the earth rotation speed, and at least one of:
a) the corrected argument of latitude of said transmitter configured substantially constant in time;
b) the corrected mean motion of said transmitter configured equal to zero;
   wherein the position of said transmitter at one specific time instant configured equal to the actual position of said transmitter.

Said GNSS receiver, wherein said orbit configured polar and circular, stationary over the longitude on which said transmitter is actually located, said orbit radius equal to the distance between the earth center and the actual position of said transmitter, and the corrected argument of latitude of said transmitter equal to the latitude on which said transmitter is actually located.

Said GNSS receiver, wherein at least one of: the actual transmission time instant or the reported transmission time instant of said reference signals, configured to, at least one of:
a) the actual transmission time of other reference signals;
b) the reported transmission time of other reference signals;
c) the actual transmission time of other reference signals corrected according to the actual position of said transmitter and to the reported position of said transmitter;
d) the reported transmission time of other reference signals corrected according to the actual position of said transmitter and to the reported position of said transmitter.

Said GNSS receiver, configured to calculate the position of said transmitter applying the Keplerian equations on data broadcast by said transmitter.

The above examples and description have been provided for the purpose of illustration, and are not intended to limit the scope of the invention in any way. As will be appreciated by the skilled person, the invention can be carried out in a variety of ways, not limited by specific terms or specific interpretations of terms as described above, all without exceeding the scope of the invention.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 illustrates the Basic GPS Trilateration Concept, in two dimensions. The earth globe is represented by a circle, on which the map of the world is illustrated. Three satellites are depicted orbiting in space, around the earth, positioned at (x₁, y₁, z₁), (x₂, y₂, z₂) and (x₃, y₃, z₃), respectfully. A receiver depicted on the earth surface, with position coordinates (x, y, z). Three circles, each around a different satellite, with radii of C×T₁, C×T₂ and C×T₃, accordingly, depict the range from each satellite to the receiver, said three circles intersecting at the receiver. At the bottom of FIG. 1, the three navigation equations representing the Trilateration method, are shown:

√[(x−x₁)²+(y−y₁)²+(z−z₁)²]=C×[Transmission Time from SV₁ to Receiver]=C×T₁

√[(x−x₂)²+(y−y₂)²+(z−z₂)²]=C×[Transmission Time from SV₂ to Receiver]=C×T₂

√[(x−x₃)²+(y−y₃)²+(z−z₃)²]=C×[Transmission Time from SV₃ to Receiver]=C×T₃

FIG. 2 illustrates the orbit of a Space Vehicle (SV), i.e. satellite, around the Earth.

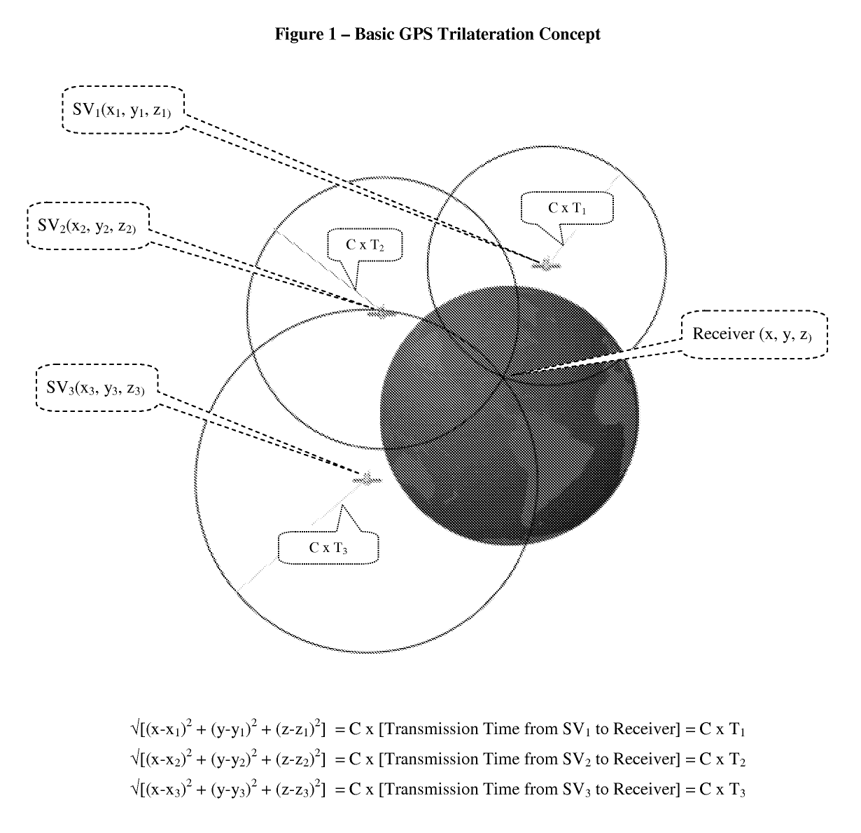

On the left side, figure (a) depicts the Orbit Plane in two dimensions, as an ellipse with semi major axis (a), eccentricity (e), and depicting the center of the earth on its right focus. The satellite position (P), depicted on the ellipse, at a distance (r) from the center of the earth, and angle (TA) from the ellipse semi major axis.

On the right side, figure (b) illustrates the satellite Orbit in a three dimensional Cartesian coordinate system, with the earth center at the origin, X-axis and Y-axis on the equator plane and Z-axis aligned with the earth rotation axis. The earth equator plane illustrated horizontally, on the X-Y-plane, the satellite orbit plane shown inclined at angle (i) to the equator plane, and crossing the equator plane at angle Ω from the X-axis. Angle w indicates the direction of the semi major axis of the orbit ellipse, also known as perigee.

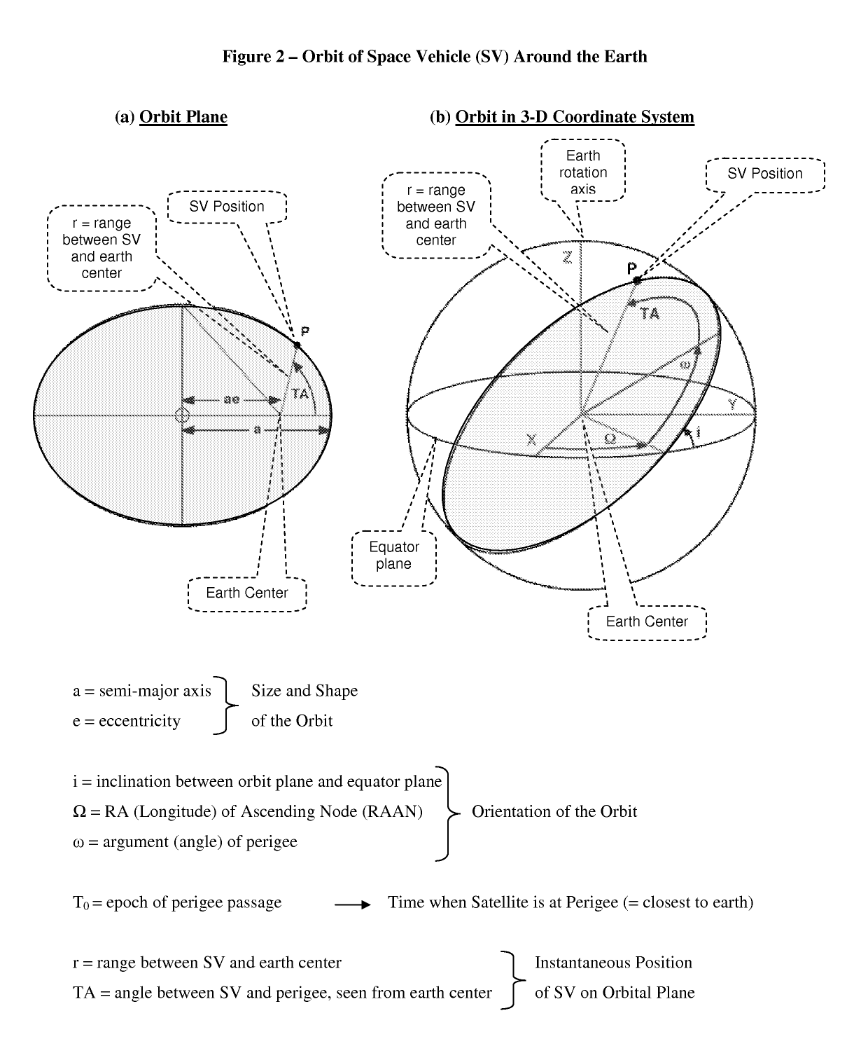

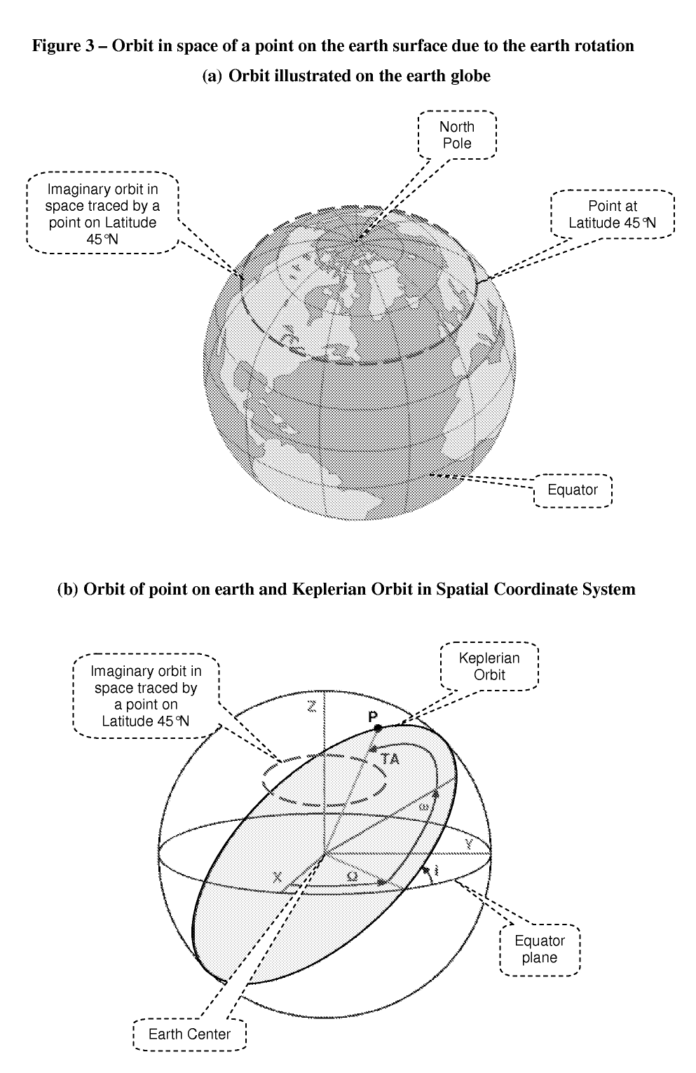

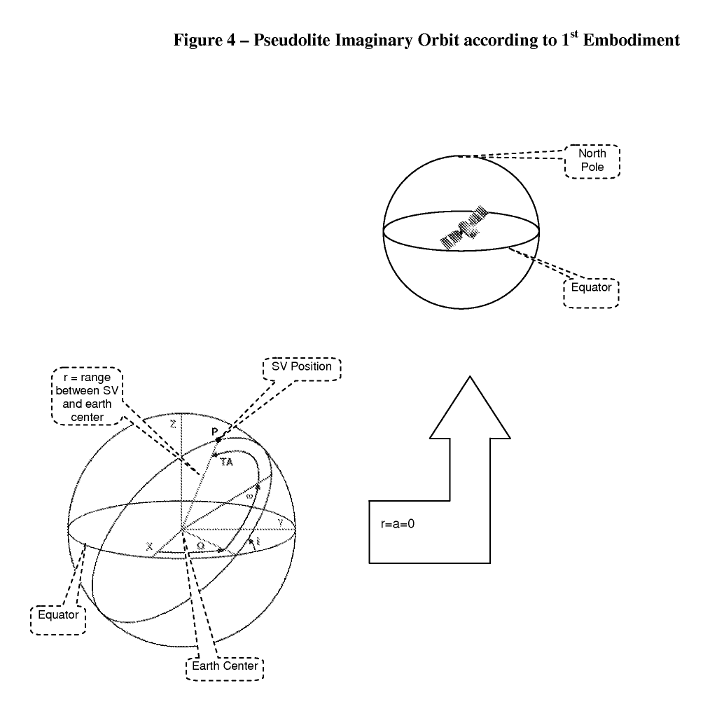

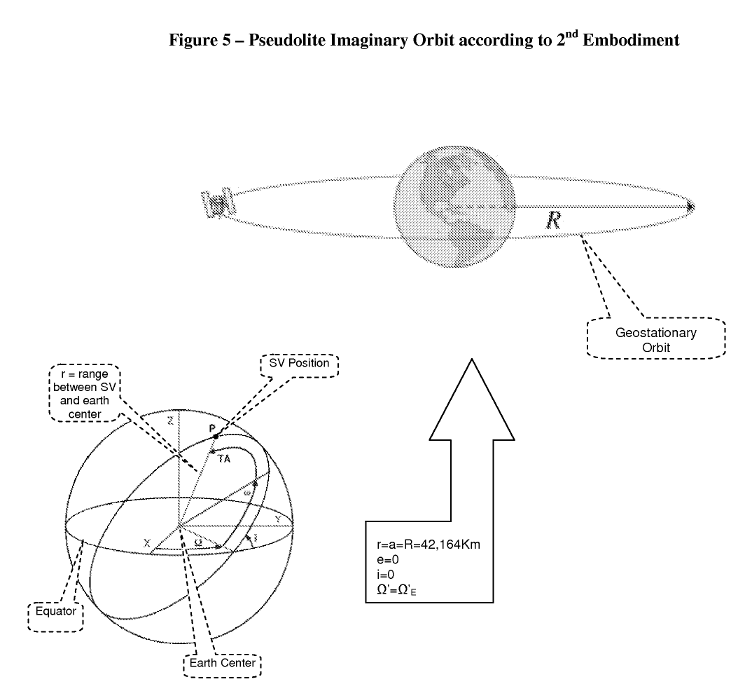

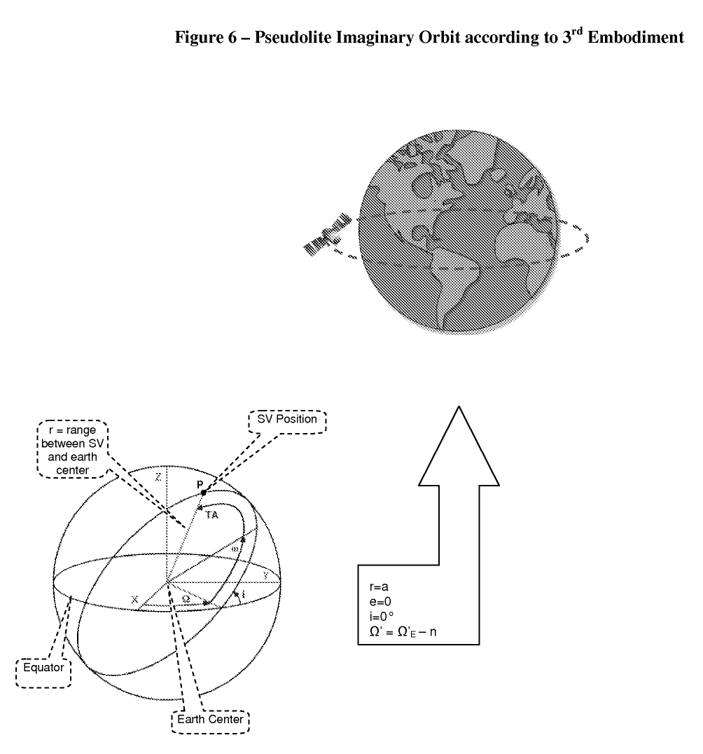

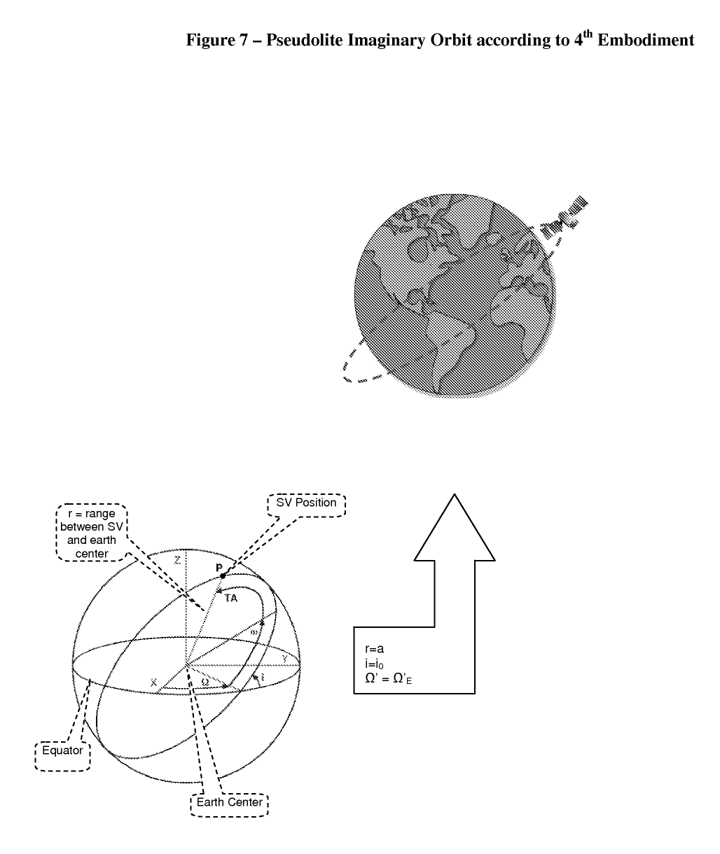

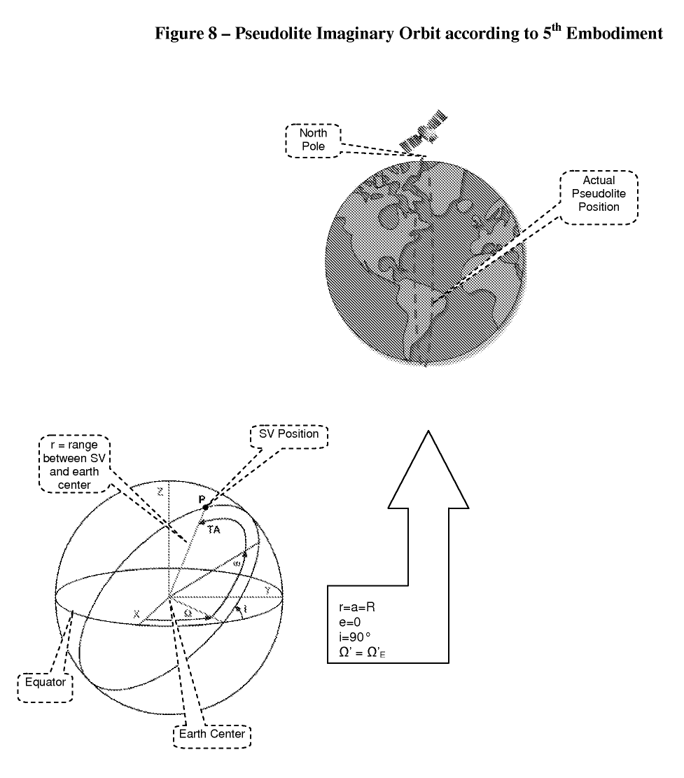

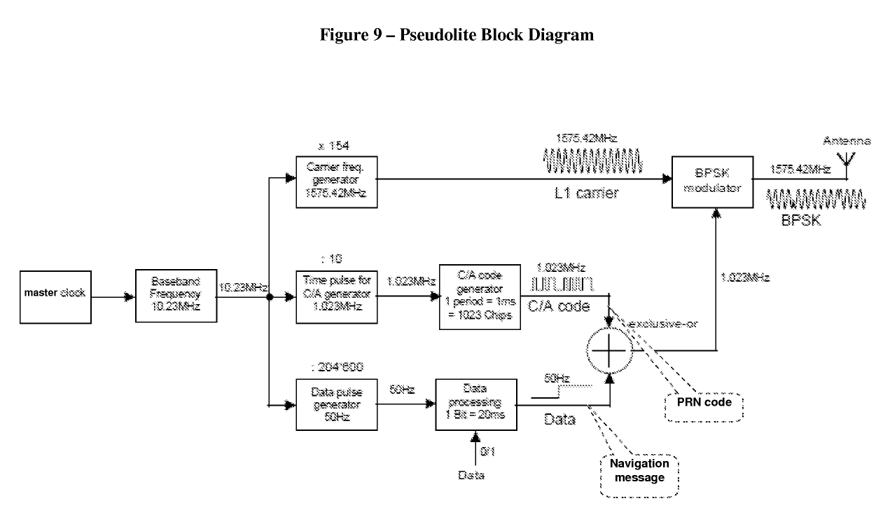

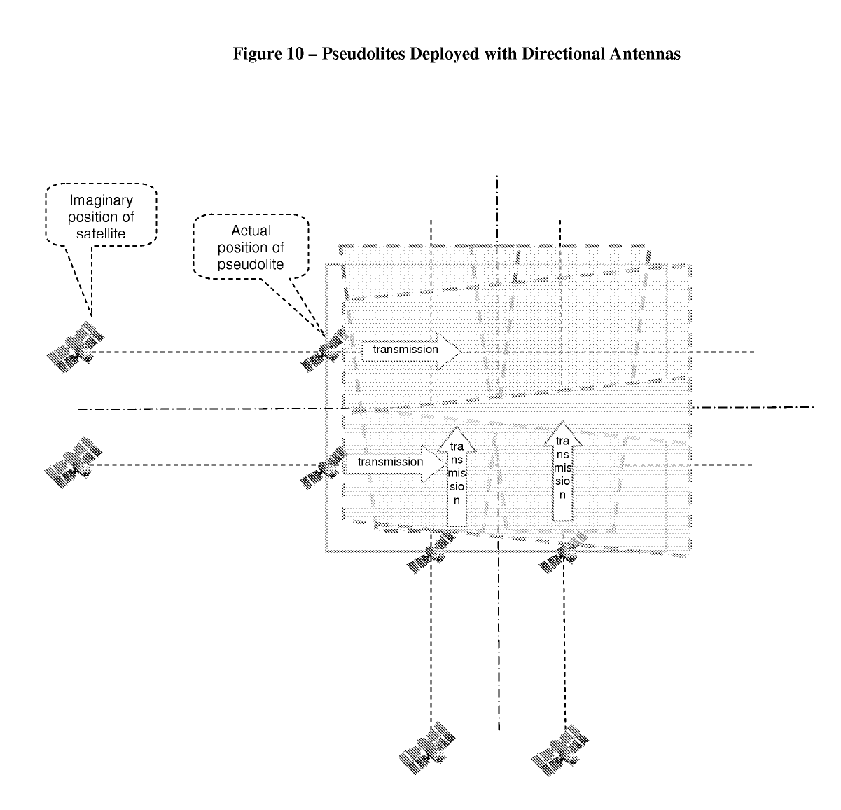

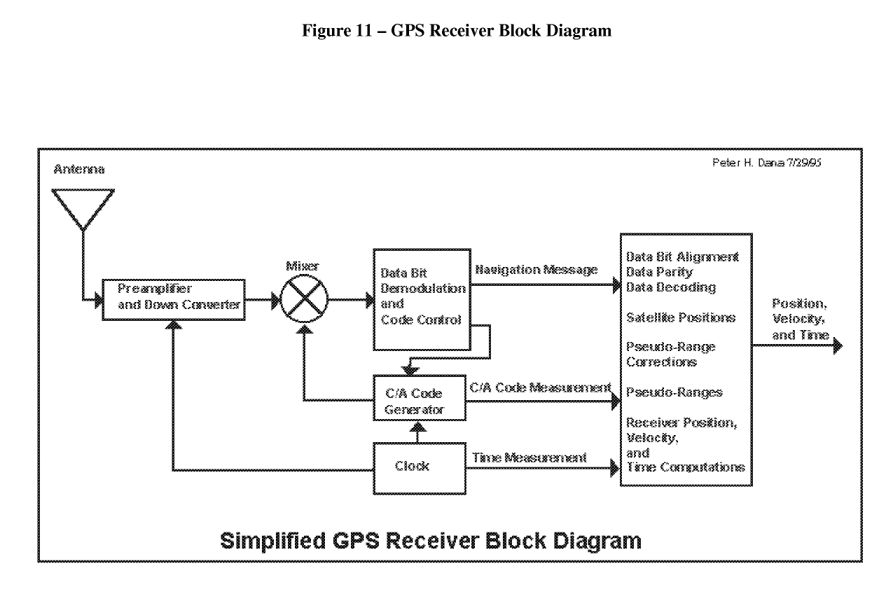

At the bottom of FIG. 2, the six Keplerian Elements are defined:
a=semi-major axis
e=eccentricity
i=inclination between orbit plane and equator plane
Ω=RA (Longitude) of Ascending Node (RAAN)
ω=argument (angle) of perigee
T₀=Time when Satellite is at Perigee (=closest to earth)

Also defined at the bottom of FIG. 2 are the satellite polar coordinates:
r=range between SV and earth center
TA=angle between SV and perigee, seen from earth center

FIG. 3 illustrates the imaginary orbit traced in space by a point on the earth surface due to the earth rotation. The upper part (a) illustrates that orbit on the earth globe. The earth globe is pictured with the continents and oceans illustrated on, as well as a grid of latitudes and longitudes. The North Pole is marked, as well as the equator. A broken (red) line over latitude 45° N marks the imaginary orbit in space traced by a point on the earth placed 45° north to the equator, due to the earth rotation around its polar axis. The lower part (b) of FIG. 3 shows a 3-D spatial Cartesian coordinate system, on which two different orbits are illustrated. The X axis and Y axis of this coordinate system are on the earth equator plane, and the Z axis aligns with the earth polar axis. The imaginary spatial orbit traced by a point on the earth at latitude 45° is depicted by a broken (red) line around the Z axis, parallel to the X-Y plane. Also, a Keplerian orbit is depicted on the same coordinate system. The Keplerian orbit is an ellipse, inclined at angle (i) to the equator, wherein the earth center is at one of this ellipse foci.

FIG. 4 illustrates the Pseudolite Imaginary Orbit according to a 1^{st} Embodiment of the present invention. At the left bottom side of the picture, the general three dimensional orbit model is depicted. A right angle arrow shows the specific configuration of some significant parameters, according to this embodiment, and at the upper side of the picture, the specific orbit model is illustrated. FIG. 4 illustrates an orbit which is degraded to a single point, right at the center of the earth, since the semi major (a) is configured to zero.

FIG. 5 illustrates the Pseudolite Imaginary Orbit according to a 2^{nd} Embodiment of the present invention. At the left bottom side of the picture, the general three dimensional orbit model is depicted. A right angle arrow shows the specific configuration of some significant parameters, according to this embodiment, and at the upper side of the picture, the specific orbit model is illustrated. FIG. 5 illustrates a geostationary orbit, since the inclination (i) is configured to zero, the ellipse eccentricity is configured to zero, the semi major axis (a) is configured to 42,164 Km, and the orbit rotation speed (Ω′) configured equal to the earth rotation speed (Ω_{E}′).

FIG. 6 illustrates the Pseudolite Imaginary Orbit according to a 3^{rd} Embodiment of the present invention. At the left bottom side of the picture, the general three dimensional orbit model is depicted. A right angle arrow shows the specific configuration of some significant parameters, according to this embodiment, and at the upper side of the picture, the specific orbit model is illustrated. FIG. 6 illustrates an equatorial circular orbit, since the inclination (i) is configured to zero and the ellipse eccentricity is configured to zero. The semi major axis (a) is not necessarily the geostationary radius, and the orbit rotation speed (Ω′) configured equal to the earth rotation speed (Ω_{E}′) minus the angular average speed (n) due to the gravitational force at this distance from the earth center.

FIG. 7 illustrates the Pseudolite Imaginary Orbit according to a 4^{th} Embodiment of the present invention. At the left bottom side of the picture, the general three dimensional orbit model is depicted. A right angle arrow shows the specific configuration of some significant parameters, according to this embodiment, and at the upper side of the picture, the specific orbit model is illustrated. FIG. 7 illustrates a circular orbit (e=0), inclined at angle (i) to the equator, stationary in reference to the earth surface, since the orbit rotation speed (Ω′) is configured equal to the earth rotation speed (Ω_{E}′).

FIG. 8 illustrates the Pseudolite Imaginary Orbit according to a 5^{th} Embodiment of the present invention. At the left bottom side of the picture, the general three dimensional orbit model is depicted. A right angle arrow shows the specific configuration of some significant parameters, according to this embodiment, and at the upper side of the picture, the specific orbit model is illustrated. FIG. 8 illustrates a circular (e=0) polar) (i=90°) orbit, stationary in reference to the earth surface, since the orbit rotation speed (Ω′) is configured equal to the earth rotation speed (Ω_{E}′). The initial phase of the RAAN is configured right over the longitude where the pseudolite is actually located, and the semi major axis (a) is set to the distance between the center of the earth to the actual position of the pseudolite.

FIG. 9 illustrates the Pseudolite Block Diagram, according to the present invention. From left side, a master clock block is depicted, generating a basic frequency of 10.23 MHz used to derive the carrier frequency L1=1575 MHz (depicted at the upper branch), the PRN code at 1.023 MHz (depicted at the center branch), and the navigation message data at 50 Hz (depicted at the lower branch). A round XOR block illustrates the exclusive or function employed on the data and PRN code, and a BPSK block illustrates the modulation of the XOT product on L1, which is routed to the antenna, at the right side of the picture.

FIG. 10 illustrates the Pseudolites Deployed with Directional Antennas.

A rectangle (orange color) illustrates the boundaries of a location, e.g. an indoor hall in a mole, in which four pseudolites are deployed, each pseudolite attached to a directional antenna. The pseudolites are illustrated by satellite icons, placed on said rectangular boundaries, two of the pseudolites are placed on the left vertical boundary, and two other pseudolites are placed on the bottom horizontal boundary. Four shadowed icons of satellites, two of them shown at the most left side of the picture, and two shown at the most bottom side of the picture, illustrate the imaginary position of the transmitters as reported by the pseudolite. Each of the four pairs [pseudolite+imaginary satellite] is connected by a broken line, which extends into the rectangular location, wherein the antenna attached to each pseudolite is directed along this line. The four transmission lobes, related to said four pseudolite antennas, are depicted by four trapezoid patterns, two horizontal and two vertical, separating the illustrated location into four sectors, each sector covered by one horizontal transmission pattern and one vertical transmission pattern.

FIG. 11 illustrates the GPS Receiver Block Diagram, according to the present invention. An antenna is depicted at the left side, from which the received signal is routed to a preamplifier and down converter, then right to a mixer. The mixer gets a replica of a C/A code that relates to a specific satellite (only one receiver channel is shown), and correlates it with the received base band signal. the mixer output is routed to the “Data Bit Demodulation and Code Control” block, which decodes the navigation message and is used to determine the transmission time instant. The block at the right side illustrates a processor that calculates the satellite position and Pseudorange, and using 4 such measurements, determines its self position, velocity and time.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

The invention is directed to a method for determining the position of a Global Navigation Satellite System (GNSS) receiver, by broadcasting reference signals from at least one transmitter substantially stationary in reference to the surface of the earth, comprising the steps of:

a) configuring said reference signals to:
(i) specify an imaginary orbit in space on which said transmitter is reported to be, said orbit based on an ellipse, one of said ellipse foci at the center of the earth, and at least one point on said orbit substantially stationary in reference to the surface of the earth;
(ii) indicate the position of said transmitter substantially at said stationary point; and,
   b) configuring said receiver to detect said reference signals, and:
(i) calculate the momentarily position of said transmitter on said imaginary orbit in space;
(ii) estimate the distance to said momentarily position;
(iii) determine self position, upon calculating the position of and estimating the distance to typically four transmitters.

FIG. 2 depicts said imaginary orbit, also known as a Keplerian orbit, which also represents the orbit of a GPS satellite around the earth. The left part of FIG. 2 (a—orbit plane) shows a two dimensional picture of the orbit, i.e, an ellipse with semi major axis (a.). The center of the earth is depicted at the right focus of the ellipse, which is the origin of the polar coordinate system used to define the satellite position. The satellite position (P) is shown on the orbit, at a range (r) from the origin and angle TA measured from the semi major axis. A skilled person probably realizes that the eccentricity of the ellipse in this picture is not zero, since the semi major axis is not equal to the semi minor axis and this ellipse is not a circle.

The right part of FIG. 2 (b) depicts the orbit in a three dimensional Cartesian Coordinate System, where the origin of the coordinates is the earth center, the Z axis is pointed to the north pole, i.e. aligned with the earth rotation axis, and X-Y are on the equator plane. The X axis is pointed to the vernal equinox (nor shown), i.e. First Point of Aries. The orbit is shown inclined. at angle (i) to the equator, the RAAN (Ω) is indicated on the X-Y plane, and the perigee angle (ω) is indicated on the orbit plane. The True Anomaly (TA) is the angle on the orbit plane between the perigee and the position of the satellite, as seen from the earth center.

FIG. 3 illustrates the imaginary trace or orbit in space made by a pseudolite installed on the surface of the earth due to the earth rotation,. The upper part (a) illustrates said orbit on the earth globe. As a skilled person may appreciate, as the earth rotates around its axis, the pseudolite follows a circle in space, around the earth axis, at constant latitude. This orbit is also depicted in the lower part (b) of FIG. 3, in the background of a spatial three dimensional Cartesian coordinate system, around the Z axis and parallel to the X-Y plane. Also, a Keplerian orbit is depicted on the same coordinate system, i.e. an ellipse, with one of its foci at the earth center, inclined at angle (i) to the equator. As a skilled person may appreciate, the orbit made by the pseudolite cannot be represented as Keplerian orbit since it is not around the earth center.

So, since a GPS receiver determines its self position based on the orbital representation broadcast by each satellite, assuming Keplerian orbits, it would not interpret correctly parameters broadcast by pseudolites indicating their true orbit in space, as depicted in FIG. 3.

Then, the basic strategy disclosed by the present invention is to broadcast “faked” Keplerian parameters, by pseudolites that “pretend” being on orbit around the center of the earth, however indicating that they stay constantly at one specific point on said orbit, in reference to the earth surface. This way, the indicated position of the pseudolite is stationary in reference to the earth surface, i.e. stationary in the ECEF coordinate system, so keeping a fixed relation in space between the reported position and actual position of the transmitter. Furthermore, the present invention discloses some methods to report the pseudolite position right at its actual position, so that the Trilateration calculation performed by the receiver will achieve accurate results.

The present invention discloses several ways which either alone, or in combination, provide a representation of a stationary pseudolite, in the ECEF coordinate system, still using the Keplerian orbit model, by specifying:
a) semi-major axis of said ellipse equal to zero, or to the distance between the center of the earth and a specific point on the earth surface, or to the geostationary radius;
b) eccentricity of said ellipse equal to zero;
c) inclination between said orbit and the earth equator equal to zero, or to ninety degrees;
d) rotation speed of said orbit around the earth axis equal to zero, or to the earth rotation speed, or to the earth rotation speed plus or minus the angular speed on an equatorial orbit due to the earth gravitational force;
e) corrected argument of latitude of said transmitter on its orbit substantially constant in time;
f) corrected mean motion of said transmitter on its orbit equal to zero.

The most basic stationary Keplerian orbit is a singular point right on the center of the earth, specified by the semi-major axis of the orbit ellipse equal to zero. This method emulates a satellite stationary at the center of the earth.

According to a 1^{st} embodiment of the present invention, as depicted in FIG. 4, a pseudolite broadcast reference signals reporting a semi-major axis (a)=0, and also Cᵣₛ=C_{rc}=0. The GPS receiver, employing equation (8), calculates rₖ=0, and from equation (11) determines the pseudolite coordinates: xᵢ=yᵢ=zᵢ=0.

Specifying the semi-major axis of the orbit ellipse equal to the geostationary radius, in combination with a zero inclination, emulates a satellite on a geostationary orbit, where as a skilled person may appreciate, a satellite is stationary over the earth surface. On a geostationary orbit, the revolution period (P) is exactly one sidereal day, i.e. 86,164.0905 mean solar seconds, and using Kepler's 3^{rd} law, expressed by the equation √(GM_{E}/a³)=2π/P, then a=42,164,172 m.

Where GM_{E}=Newton's Gravitational constant * the earth mass=3.986005×10¹⁴ m³/s²

The present invention discloses also specifying a rotation speed of said orbit around the earth axis equal to the earth rotation speed, and configuring at least one of:
a) the corrected argument of latitude of said transmitter substantially constant in time;
b) the corrected mean motion of said transmitter equal to zero;
   and indicating the position of said transmitter at one specific time instant, equal to the actual position of said transmitter.

According to a 2^{nd} embodiment of the present invention, as depicted in FIG. 5, a pseudolite broadcast reference signals reporting a semi-major axis (a)=42,164,172 m, and also i₀=i′=Cᵢₛ=C_{ic}=0. The GPS receiver, employing equation (10), calculates iₖ=0, and from equation (11) determines the pseudolite coordinates:

$$\vert \begin{matrix}{x}_{i} \\ {y}_{i} \\ {z}_{i}\end{matrix} \vert = \vert \begin{matrix}{r}_{k} cos ( {u}_{k} ) cos {Ω}_{k} - {r}_{k} sin ( {u}_{k} ) sin {Ω}_{k} \\ {r}_{k} cos ( {u}_{k} ) sin {Ω}_{k} + {r}_{k} sin ( {u}_{k} ) cos {Ω}_{k} \\ 0\end{matrix} \vert = \vert \begin{matrix}{r}_{k} cos ( {u}_{k} + {Ω}_{k} ) \\ {r}_{k} sin ( {u}_{k} + {Ω}_{k} ) \\ 0\end{matrix} \vert$$

Further, according to this 2^{nd} embodiment, the ellipse eccentricity (e) is reported as zero, defining a circular orbit, or more precisely: e=Cᵣₛ=C_{rc}=0. The GPS receiver, employing equation (8), calculates rₖ=a, so the pseudolite coordinates are reduced to:

$$\vert \begin{matrix}{x}_{i} \\ {y}_{i} \\ {z}_{i}\end{matrix} \vert = \vert \begin{matrix}a cos ( {u}_{k} + {Ω}_{k} ) \\ a sin ( {u}_{k} + {Ω}_{k} ) \\ 0\end{matrix} \vert$$

Then if (uₖ+Ωₖ)=constant in time, so will be the pseudolite position.

From equation (9) it is clear that specifying the rotation speed of the orbit around the earth axis equal to the earth rotation speed, i.e. reporting Ω′−Ω′_{E}, ensures constant RAAN (Ωₖ) versus time.

Finally, the corrected Argument of Latitude (uₖ) is configured to be constant, in order to achieve a reported constant position of a pseudolite on a Keplerian geostationary orbit.

From equations (2), (3), (4), for e=0, TA(t)=E(t)=M(t)=M₀+n(t−tₒₑ).

Equation (13) expresses (n) more precisely: nₐ=n₀+Δnₐ

where:
n₀=computed value of mean motion=√[GM_{E}/(a₀)³]
Δnₐ=Mean Motion Difference From Computed Value

So furthermore, according to this 2^{nd} embodiment, the reference signals indicate:
Δnₐ=−n₀, and also Cᵤₛ=Cᵤₛ=0.

The GPS receiver, employing equation (13), calculates nₐ=0, and employing equation (7):
uₖ=(M₀+ω)), is constant in time, and since configuring Ω′−Ω′_{E} ensures that Ωₖ is also constant in time, so is (uₖ−Ωₖ) constant in time.

A modern version of the GPS signals (L1C) further refines:

Δnₐ=Δn₀+½(Δn₀)′tₖ

### Where:

Δn₀=mean motion difference from computed value at reference time
(Δn₀)′=rate of mean motion difference from computed value

So furthermore, according to variation (a) of the 2^{nd} embodiment, the reference signals indicate:
Δn₀=−n₀ and (Δn₀)′=0, and also Cᵤₛ=C_{uc}=0.

So, the GPS receiver is configured to resolve equation (13), calculating nₐ=0, then employing equation (7) determine uₖ=(M₀+ω)), which is constant in time.

According to a 3^{rd} embodiment of the present invention, as depicted in FIG. 6, a pseudolite broadcast reference signals reporting a specific semi-major axis (a), and i₀=i′=Cᵢₛ=C_{ic}=0, and also e=Cᵣₛ=C_{rc}=0. The GPS receiver, employing equation (10), calculates iₖ=0, and employing equation (8), calculates rₖ=a, and employing equation (11) determines the pseudolite coordinates:

$$\vert \begin{matrix}{x}_{i} \\ {y}_{i} \\ {z}_{i}\end{matrix} \vert = \vert \begin{matrix}a cos ( {u}_{k} + {Ω}_{k} ) \\ a sin ( {u}_{k} + {Ω}_{k} ) \\ 0\end{matrix} \vert$$

And as according to the 2^{nd} embodiment, if (uₖ+Ωₖ)=constant, so will be the pseudolite position. From equations (2), (3), (4), for e=0, TA(t)=E(t)=M(t)=M₀+n(t−tₒₑ).

Then further according to this 3^{rd} embodiment, the pseudolite reports zero correction terms to the Argument of Latitude, i.e. Cᵤₛ=C_{uc}=0. The GPS receiver, employing equation (7), calculates:

uₖ=(TA+ω)ₖ=M₀+n(t−tₒₑ)+ω

Calculating (uₖ+Φₖ) according to equation (9):

uₖΩₖ=M₀+n(t−tₒₑ)+ω+Ω₀+(Ω′−Ω′_{E})(t−tₒₑ)−Ω′_{E}*tₒₑ=M₀+ω+Ω₀−Ω′_{E}*tₒₑ+(n+Ω′−Ω′_{E})(t−tₒₑ)

Thus, in order to configure (uₖ+Ωₖ)=constant in time, according to this 3^{rd} embodiment, the reference signals specify n+Ω′−Ω′_{E}=0, i.e. Ω′=Ω′_{E}−n. In other words, specifying the rotation speed of said orbit around the earth axis (Ω′) equal to the earth rotation speed (Ω′_{E}) minus the angular speed on an equatorial orbit due to the earth gravitational force (n). The skilled person may note that according to this 3^{rd} embodiment, the imaginary orbit radius of the pseudolite is not necessarily geostationary; rather (a) may be configured to any value. Particularly, if the pseudolite is installed at latitude θ, then configuring a=R cos θ, where R is the earth radius, will indicate an imaginary orbit for that pseudolite around the earth center, at a radius equal to the actual radius of the pseudolite around the earth axis. Furthermore, configuring uₖ+Ωₖ=M₀+ω+Ω₀−Ω′_{E}*tₒₑ=the actual longitude of the pseudolite, ensures that the imaginary position of the pseudolite will be on the equator plane right below the actual pseudolite position.

According to a 4^{th} embodiment of the present invention, as depicted in FIG. 7, a pseudolite broadcast reference signals reporting a specific semi-major axis (a), and i′=Cᵢₛ=C_{ic}=0, and e=Cᵣₛ=C_{rc}=0, and also Ω′=Ω′_{E}.

The GPS receiver, employing equation (10), calculates iₖ=i₀, and employing equation (8), calculates rₖ=a, and employing equation (9) calculates Ωₖ=Ω₀−Ω′_{E}*tₒₑ, and employing equation (11) determines the pseudolite coordinates:

$$\vert \begin{matrix}{x}_{i} \\ {y}_{i} \\ {z}_{i}\end{matrix} \vert = \vert \begin{matrix}a cos ( {u}_{k} ) cos ( {Ω}_{0} - {Ω}_{E}^{′} * {t}_{oe} ) - a sin ( {u}_{k} ) sin ( {Ω}_{0} - {Ω}_{E}^{′} * {t}_{oe} ) cos {i}_{0} \\ a cos ( {u}_{k} ) sin ( {Ω}_{0} - {Ω}_{E}^{′} * {t}_{oe} ) + a sin ( {u}_{k} ) cos ( {Ω}_{0} - {Ω}_{E}^{′} * {t}_{oe} ) cos {i}_{0} \\ a sin ( {u}_{k} ) sin {i}_{0}\end{matrix} \vert$$

Obviously, the only parameter variable in time at the right side of the above equation is uₖ.

Since e=0, then TA(t)=E(t)=M(t)=M₀+n(t−tₒₑ).

So according to equation (7), the GPS receiver calculates:

uₖ=Φₖ+Cᵤₛ sin(2Φₖ)+C_{uc} cos(2Φₖ)

### Wherein:

Φₖ=(TA+ω)ₖ=M₀+ntₖ+ω=M₀+n(t−tₒₑ)+ω

From this point, according to the 4^{th} embodiment, the corrected argument of latitude of said transmitter is configured constant in time, yet differently than according to the 2^{nd} embodiment.

So further according to a 4^{th} embodiment, the reference signals specify:
Cᵤₛ=(Φ₀−Φₖ)sin(2Φₖ) and C_{uc}=(Φ₀−Φₖ)cos(2Φₖ), where Φ₀ is constant in time.

Then, the GPS receiver, employing equation (7) will calculate:

uₖ=Φₖ+(Φ₀−Φₖ)sin²(2Φₖ)+(Φ₀−Φₖ)cos²(2Φₖ)=Φₖ+(Φ₀−Φₖ)=Φ₀

So, according to the 4^{th} embodiment, the reference signals specify the rotation speed of the orbit equal to the earth rotation speed, and a corrected argument of latitude constant in time.

The present invention discloses also specifying a circular polar orbit, stationary over the longitude on which said transmitter is actually located, said orbit radius equal to the distance between the earth center and the actual position of said transmitter, and the corrected argument of latitude of said transmitter equal to the latitude on which said transmitter is actually located.

According to a 5^{th} embodiment of the present invention, as depicted in FIG. 8, the reference signals broadcast by a pseudolite are configured as following:
a) semi-major axis of ellipse equal to the distance between the center of the earth and a specific point on the earth surface;
b) eccentricity of said ellipse equal to zero;
c) inclination between said orbit and the earth equator equal to ninety degrees;
d) rotation speed of said orbit around the earth axis equal to the earth rotation speed;
e) corrected argument of latitude of said transmitter on its orbit substantially constant in time.

So, according to this 5^{th} embodiment, the pseudolite specifies: a specific semi-major axis (a), e=0 and also Cᵣₛ=C_{rc}=0, i₀=π/2 and i′=Cᵢₛ=C_{ic}=0, and Φ′=Φ′_{E}.

The GPS receiver, employing equation (10), calculates iₖ=π/2, and employing equation (8), calculates rₖ=a, and employing equation (9) calculates Φₖ=Φ₀−Φ′_{E}*tₒₑ, and employing equation (11) determines the pseudolite coordinates:

$$\vert \begin{matrix}{x}_{i} \\ {y}_{i} \\ {z}_{i}\end{matrix} \vert = \vert \begin{matrix}a cos ( {u}_{k} ) cos ( {Ω}_{0} - {Ω}_{E}^{′} * {t}_{oe} ) \\ a cos ( {u}_{k} ) sin ( {Ω}_{0} - {Ω}_{E}^{′} * {t}_{oe} ) \\ a sin ( {u}_{k} )\end{matrix} \vert$$

From equations (2), (3), (4), for e=0, TA(t)=E(t)=M(t)=M₀+n(t−tₒₑ).

Obviously, the only parameter variable in time at the right side of the above equation is the corrected argument of latitude (uₖ).

According to equation (7), the GPS receiver calculates:

uₖ=Φₖ+Cᵤₛ sin(2Φₖ)+C_{uc} cos(2Φₖ)

### Wherein:

Φₖ=(TA+ω)ₖ=M₀+ntₖ+ω=M₀+n(t−tₒₑ)+ω

And wherein uₖ is configured to be constant in time, according to the 2^{nd} embodiment (mean motion configured equal to zero) or according to the 4^{th} embodiment of the present invention (manipulating the Amplitude of the Sine and Cosine Harmonic Correction Terms to the Argument of Latitude), or otherwise. Either way, the result is a constant in time corrected argument of latitude: uₖ=Φ₀.

Furthermore, according to this 5^{th} embodiment, the semi major (a) is specified as the distance between the earth center and the actual position of said transmitter, the fixed RAAN (Φₖ) is specified equal to the longitude on which said transmitter is actually located, so LON(pseudolite)=Ω₀−Ω′_{E}*tₒₑ, and LAT(pseudolite)=Φ₀.

The present invention discloses also manipulating the transmission time instant as well as the indication of transmission time instant represented in the reference signals broadcast by the pseudolite, configuring at least one of: the actual transmission time instant or the reported transmission time instant of said reference signals, to at least one of:
a) the actual transmission time of other reference signals;
b) the reported transmission time of other reference signals;
c) the actual transmission time of other reference signals corrected according to the actual position of said transmitter and to the reported position of said transmitter;
d) the reported transmission time of other reference signals corrected according to the actual position of said transmitter and to the reported position of said transmitter.

As detailed in the BACKGROUND OF THE INVENTION, a GNSS receiver employs a mathematical method called “Trilateration”, wherein the distance between the receiver and each satellite is estimated measuring the travelling time of a signal between the satellite and the receiver, multiplied by the speed of light. This travelling time is measured using the transmission time instant indicated by the transmitter. Moreover, as a skilled person may appreciate, the GPS Trilateration method assumes that all the satellites transmit simultaneously, i.e. all satellites transmit at the same time the first bit of the navigation message and the first chip of the PRN sequence, all synchronized to one accurate time scale called “GPS time”, up to a slight deviation per satellite, named Δt_{SVi}, which is reported and accounted for in equation (1).

The Trilateration method employed by the GPS requires all the satellites to transmit simultaneously in order to “freeze” a momentarily spatial position of satellites, at a certain time, for which the navigation equations (1) are resolved. Yet, since the pseudolites according to the present invention are stationary, whenever the time is “frozen” and a snapshot of pseudolites position is taken, the pseudolites are at the same position, so strict time synchronization of transmission timing of pseudolites is not a must. Still, it is advised to configure the pseudolite transmission time so that the signals used by the receiver to resolve equation (1) will arrive at the receiver not too far (in time) from each other, particularly if satellite signals and pseudolite signals are used together.

The reported time of transmission, however, is essential for resolving the navigation equations (1) correctly. Preferably, according to the present invention, four or more pseudolites are deployed in a certain location and broadcast reference signals, wherein each pseudolite reporting a position identical to its actual position, and all pseudolites reporting substantially the same transmission time.

Preferably, the GPS time reference should be used by the pseudolites reporting their transmission time instant, as reflected in the navigation message data and in the phase of PRN codes, particularly if a GPS receiver may detect real satellites as well as pseudolites. Yet, for a standalone system of pseudolites, which report their actual position, this is not a must.

So, further according to the 5^{th} embodiment of the present invention, four or more pseudolites are deployed in an indoor location, such as a tunnel or underground parking lot, wherein all pseudolites are connected by wire, or wirelessly, for synchronization purposes, so all pseudolites transmit simultaneously and report the actual transmission time instant, and zero time correction (Δt_{SVi}).

The present invention discloses also deploying two or more pseudolites, either at different points or substantially at the same point.

According to a 6^{th} embodiment of the present invention, four pseudolites are configured according to the 5^{th} embodiment, and installed side by side at one specific point in an underground hangar of airplanes. All pseudolites (i=1−4) broadcast reference signals specifying the same position (xᵢ, yᵢ, zᵢ), which is their actual position. A GPS receiver in said hangar, calculates the same pseudo range (PRᵢ) to all pseudolites, so employing equation (1), resolves its position as being on a sphere with a radius PRᵢ and centered at (xᵢ, yᵢ, zᵢ). Practically, and neglecting measurement errors, if the GPS receiver is 5 meters away from that assemblage of pseudolites, it will indicate a position 5 m from the pseudolites, though not necessarily at its exact position. That may serve, for example, for testing the aircraft GPS receiver, still saving the burden of installing four pseudolites at four different points in that location or routing a GPS antenna outside of that hangar where real satellites may be detected.

The present invention discloses also configuring the pseudolite signals for pseudo random noise modulation, by two or more different spreading sequences.

So, furthermore, the four pseudolites according to the 6^{th} embodiment of the present invention can be integrated into a single device, instead of four separate devices. All the pseudolite parts and functions can be unified then; just that four different PRN codes should be generated.

The present invention discloses also configuring the pseudolite signals for pseudo random noise modulation, by a spreading sequence which is not employed by GNSS satellites in the area where said transmitter is deployed;

According to EGNOS portal (June 2011), http://egnos-portal.gsa.europa.eu/discover-egnos/about-egnos/what-is-sbas-

“Several countries have implemented their own satellite-based augmentation system. Europe has the European Geostationary Navigation Overlay Service (EGNOS) which covers Western Europe and beyond. The USA has its Wide Area Augmentation System (WAAS). Japan is covered by its Multi-functional Satellite Augmentation System (MSAS). India has launched its own SBAS programme named GPS and GEO Augmented Navigation (GAGAN) to cover the Indian subcontinent.”

“All of the systems comply with a common global standard and are therefore all compatible (do not interfere with each other) and interoperable (a user with a standard receiver can benefit from the same level of service and performance whether located in the EGNOS or WAAS coverage area).”

So according to the present invention, pseudolites deployed in the USA will preferably be configured to use EGNOS PRN codes, or MSAS codes, or GAGAN codes.

Similarly, pseudolites deployed in Europe will preferably be configured to WAAS or MSAS or GAGAN codes, and so on.

The invention is further directed to a device, a radio transmitter, for determining the position of a Global Navigation Satellite System (GNSS) receiver, by broadcasting reference signals from said transmitter, said transmitter substantially stationary in reference to the surface of the earth, wherein said reference signals configured to:
(i) specify an imaginary orbit in space on which said transmitter is reported to be, said orbit based on an ellipse, one of said ellipse foci at the center of the earth, and at least one point on said orbit substantially stationary in reference to the surface of the earth;
(ii) indicate the position of said transmitter substantially stationary at said point;
   and said receiver configured to detect said reference signals, and:
(i) calculate the momentarily position of said transmitter on said imaginary orbit in space;
(ii) estimate the distance to said momentarily position;
(iii) determine self position, upon calculating the position of and estimating the distance to typically four transmitters.

FIG. 9 depicts a block diagram of said transmitter, also known as pseudolite, according to the present invention.

The structure and various hardware blocks of such a transmitter are well known in the art. A similar transmitter is typically implemented onboard GPS satellites. The present invention, however, is focused mainly on the “Data” input to the block on the mid lower part of the diagram, marked “Data processing 1 Bit=20 ms”. These data represent the transmitted navigation message, typically clocked at 50 Hz, as shown in FIG. 9. The present invention also refers to the PRN code, a stream of pre-known bits typically clocked at 1.023 MHz, marked in FIG. 9 as “C/A code”. Both the navigation message (“Data”) and PRN code (“C/A code”) are XOR'ed, then phase modulate (BPSK) the L1 carrier. The combined signals transmitted from the antenna shown in FIG. 9 are referred in the present invention as “reference signals”.

Obviously, the present invention is not restricted to the specific parameters (e.g. carrier frequency, clock rate, series type) and sub methods (e.g. modulation mechanism, navigation message format) depicted in FIG. 9, illustrating a typical GPS transmitter; rather, appropriate parameters can be chosen in order to configure the transmitter according to the present invention to other GNSS systems, such as GLONASS and GALILEO.

According to the present invention, the data comprised in the navigation message, at the transmitter, is configured to represent an imaginary orbit in space, specifying at least one of:
a) semi-major axis of said ellipse equal to zero, or to the distance between the center of the earth and a specific point on the earth surface, or to the geostationary radius;
b) eccentricity of said ellipse equal to zero;
c) inclination between said orbit and the earth equator equal to zero, or to ninety degrees;
d) rotation speed of said orbit around the earth axis equal to zero, or to the earth rotation speed, or to the earth rotation speed plus or minus the angular speed on an equatorial orbit due to the earth gravitational force;
e) corrected argument of latitude of said transmitter on its orbit substantially constant in time;
f) corrected mean motion of said transmitter on its orbit equal to zero.

Further in said transmitter, said orbit rotation speed around the earth axis configured equal to the earth rotation speed, and at least one of:
a) the corrected argument of latitude substantially constant in time;
b) the corrected mean motion substantially equal to zero;
   wherein the position of said transmitter at one specific time instant configured equal to the actual position of said transmitter.

In said transmitter, said orbit configured polar and circular, stationary over the longitude on which said transmitter is actually located, said orbit radius equal to the distance between the earth center and the actual position of said transmitter, and the corrected argument of latitude of said transmitter equal to the latitude on which said transmitter is actually located.

In said disclosed transmitter, at least one of: the actual transmission time instant or the reported transmission time instant of said reference signals, configured to, at least one of:
a) the actual transmission time of other reference signals;
b) the reported transmission time of other reference signals;
c) the actual transmission time of other reference signals corrected according to the actual position of said transmitter and to the reported position of said transmitter;
d) the reported transmission time of other reference signals corrected according to the actual position of said transmitter and to the reported position of said transmitter.

Said transmitter configured for pseudo random noise modulation, by at least one of:
a) a spreading sequence which is not employed by GNSS satellites in the area where said transmitter is deployed;
b) two or more different spreading sequences.

The present invention discloses also that said transmitter is attached to a directional antenna, configured to point its main lobe of transmission substantially along the line between the actual position of said transmitter and the position of the transmitter as indicated by said reference signals.

FIG. 10 depicts four pseudolites deployed in an indoor location, each pseudolite attached to a directional antenna, directed along the line between the actual position (depicted by a satellite icon) and the imaginary position of the pseudolite (depicted by a shadowed satellite icon). A rectangular pattern depicts the location boundaries, on which two pseudolites transmit horizontally, and two pseudolites transmit vertically.

As a skilled person may appreciate, the overlapping of transmission lobes divides this location into 2×2 main sectors, each sector covered by one horizontal pseudolite and one vertical pseudolite. For simplicity, only two pseudolites are shown to cover each sector, yet the skilled person may extrapolate that to four pseudolites per sector, as required for the Trilateration method employed by the GPS.

This structure ensures that in the worst case, the error in position determination at a GPS receiver placed in said location, will not surpass the sector dimensions.

The invention is directed to another device, a Global Navigation Satellite System (GNSS) receiver, for determining self position by detecting reference signals broadcast by at least one transmitter specifying an imaginary orbit in space on which said transmitter is reported to be, said orbit based on an ellipse, one of said ellipse foci at the center of the earth, and at least one point on said orbit substantially stationary in reference to the surface of the earth, and said reference signals indicating the position of said transmitter substantially at said stationary point, wherein said receiver configured to detect said reference signals and:
(i) calculate the momentarily position of said transmitter on said imaginary orbit in space;
(ii) estimate the distance to said momentarily position;
(iii) determine self position, upon calculating the position of and estimating the distance to typically four transmitters.

FIG. 11 depicts the block diagram of said GPS receiver, based on a picture by Dr. Peter Dana. The structure and standard hardware blocks of such a receiver are well known in the art. The present invention, however, is focused mainly on the “Navigation Message” output from the “Data bit Demodulation and Code Control” block, in the mid upper part of the picture. From data comprised in this navigation message, the receiver calculates the orbit and the momentarily position of each satellite/pseudolite, as already discussed. The navigation message comprises also data to calculate the Pseudorange between the receiver and the satellite/pseudolite, using also the “C/A code Measurement” output from the “C/A Code Generator” block and “Time Measurement” output from the “Clock” block below, as well known in the art. Upon calculating the position of and Pseudorange to four satellites/pseudolites, the GPS receiver employs equation (1) to determine its self position. Resolving the four equations (i=1−4) represented by equation (1), to determine the four unknowns (x, y, z, Δt_{R}), is typically done numerically and iteratively, as well practiced in the art.

The present invention also discloses said GNSS receiver, wherein said imaginary orbit specifying at least one of:
a) semi-major axis of said ellipse equal to zero, or to the distance between the center of the earth and a specific point on the earth surface, or to the geostationary radius;
b) eccentricity of said ellipse equal to zero;
c) inclination between said orbit and the earth equator equal to zero, or to ninety degrees;
d) rotation speed of said orbit around the earth axis equal to zero, or to the earth rotation speed, or to the earth rotation speed plus or minus the angular speed on an equatorial orbit due to the earth gravitational force;
e) corrected argument of latitude of said transmitter on its orbit substantially constant in time;
f) corrected mean motion of said transmitter on its orbit equal to zero.

And said GNSS receiver, wherein said orbit rotation speed around the earth axis configured equal to the earth rotation speed, and at least one of:
a) the corrected argument of latitude of said transmitter configured substantially constant in time;
b) the corrected mean motion of said transmitter configured equal to zero;
   and the position of said transmitter at one specific time instant, equal to the actual position of said transmitter.

And further said GNSS receiver, wherein said orbit configured polar and circular, stationary over the longitude on which said transmitter is actually located, said orbit radius equal to the distance between the earth center and the actual position of said transmitter, and the corrected argument of latitude of said transmitter equal to the latitude on which said transmitter is actually located.

The present invention discloses also said GNSS receiver, wherein at least one of: the actual transmission time instant or the reported transmission time instant of said reference signals, configured to, at least one of:
a) the actual transmission time of other reference signals;
b) the reported transmission time of other reference signals;
c) the actual transmission time of other reference signals corrected according to the actual position of said transmitter and to the reported position of said transmitter;
d) the reported transmission time of other reference signals corrected according to the actual position of said transmitter and to the reported position of said transmitter.

Said GNSS receiver, configured to calculate the position of said transmitter applying the Keplerian equations on data broadcast by said transmitter.

In other words, the present invention discloses applying, at the GPS receiver, a similar algorithm to calculate the satellite or pseudolite position, on the navigation message data, broadcast by either the satellite or the pseudolite. As known in the art, this algorithm is based on Kepler's equations.

The above examples and description have been provided for the purpose of illustration, and are not intended to limit the scope of the invention in any way. As will be appreciated by the skilled person, the invention can be carried out in a variety of ways, not limited by specific terms or specific interpretations of terms as described above, all without exceeding the scope of the invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

The invention claimed is:

1. A method for determining the position of a Global Navigation Satellite System (GNSS) receiver, by broadcasting reference signals from at least one transmitter substantially stationary in reference to the surface of the earth, comprising the steps of:
a) configuring said reference signals to:
(i) specify an imaginary orbit in space on which said transmitter is reported to be, said orbit based on an ellipse, one of said ellipse foci at the center of the earth, and at least one point on said orbit substantially stationary in reference to the surface of the earth;
(ii) indicate the position of said transmitter substantially at said stationary point;
b) configuring said receiver to detect said reference signals, and:
(i) calculate the momentarily position of said transmitter on said imaginary orbit in space;
(ii) estimate the distance to said momentarily position;
(iii) determine self position, upon calculating the position of and estimating the distance to typically four transmitters.

2. The method as recited in claim 1, configuring said imaginary orbit to specify at least one of:
a) semi-major axis of said ellipse equal to zero, or to the distance between the center of the earth and a specific point on the earth surface, or to the geostationary radius;
b) eccentricity of said ellipse equal to zero;
c) inclination between said orbit and the earth equator equal to zero, or to ninety degrees;
d) rotation speed of said orbit around the earth axis equal to zero, or to the earth rotation speed, or to the earth rotation speed plus or minus the angular speed on an equatorial orbit due to the earth gravitational force;
e) corrected argument of latitude of said transmitter on its orbit substantially constant in time;
f) corrected mean motion of said transmitter on its orbit equal to zero.

3. The method as recited in claim 1, specifying a rotation speed of said orbit around the earth axis equal to the earth rotation speed, and configuring at least one of:
a) the corrected argument of latitude of said transmitter substantially constant in time;
b) the corrected mean motion of said transmitter equal to zero;
and indicating the position of said transmitter at one specific time instant, equal to the actual position of said transmitter.

4. The method as recited in claim 1, specifying a circular polar orbit, stationary over the longitude on which said transmitter is actually located, said orbit radius equal to the distance between the earth center and the actual position of said transmitter, and the corrected argument of latitude of said transmitter equal to the latitude on which said transmitter is actually located.

5. The method as recited in claim 1, configuring at least one of: the actual transmission time instant or the reported transmission time instant of said reference signals, to at least one of:
a) the actual transmission time of other reference signals;
b) the reported transmission time of other reference signals;
c) the actual transmission time of other reference signals corrected according to the actual position of said transmitter and to the reported position of said transmitter;
d) the reported transmission time of other reference signals corrected according to the actual position of said transmitter and to the reported position of said transmitter.

6. The method as recited in claim 1, wherein at least two of said transmitters are deployed, at different points or substantially at the same point.

7. The method as recited in claim 1, configuring said signals for pseudo random noise modulation, by at least one of:
a) a spreading sequence which is not employed by GNSS satellites in the area where said transmitter is deployed;
b) two or more different spreading sequences.

8. A radio transmitter for determining the position of a Global Navigation Satellite System (GNSS) receiver, by broadcasting reference signals from said transmitter, said transmitter substantially stationary in reference to the surface of the earth, wherein said reference signals configured to:
(i) specify an imaginary orbit in space on which said transmitter is reported to be, said orbit based on an ellipse, one of said ellipse foci at the center of the earth, and at least one point on said orbit substantially stationary in reference to the surface of the earth;
(ii) indicate the position of said transmitter substantially stationary at said point;
and said receiver configured to detect said reference signals, and:
(i) calculate the momentarily position of said transmitter on said imaginary orbit in space;
(ii) estimate the distance to said momentarily position;
(iii) determine self position, upon calculating the position of and estimating the distance to typically four transmitters.

9. The transmitter according to claim 8, said imaginary orbit configured to specify at least one of:
a) semi-major axis of said ellipse equal to zero, or to the distance between the center of the earth and a specific point on the earth surface, or to the geostationary radius;
b) eccentricity of said ellipse equal to zero;
c) inclination between said orbit and the earth equator equal to zero, or to ninety degrees;
d) rotation speed of said orbit around the earth axis equal to zero, or to the earth rotation speed, or to the earth rotation speed plus or minus the angular speed on an equatorial orbit due to the earth gravitational force;
e) corrected argument of latitude of said transmitter on its orbit substantially constant in time;
f) corrected mean motion of said transmitter on its orbit equal to zero.

10. The transmitter according to claim 8, said orbit rotation speed around the earth axis configured equal to the earth rotation speed, and at least one of:
a) the corrected argument of latitude of said transmitter configured substantially constant in time;
b) the corrected mean motion of said transmitter configured equal to zero;
wherein the position of said transmitter at one specific time instant configured equal to the actual position of said transmitter.

11. The transmitter according to claim 8, wherein said orbit configured polar and circular, stationary over the longitude on which said transmitter is actually located, said orbit radius equal to the distance between the earth center and the actual position of said transmitter, and the corrected argument of latitude of said transmitter equal to the latitude on which said transmitter is actually located.

12. The transmitter according to claim 8, wherein at least one of: the actual transmission time instant or the reported transmission time instant of said reference signals, configured to, at least one of:
a) the actual transmission time of other reference signals;
b) the reported transmission time of other reference signals;
c) the actual transmission time of other reference signals corrected according to the actual position of said transmitter and to the reported position of said transmitter;
d) the reported transmission time of other reference signals corrected according to the actual position of said transmitter and to the reported position of said transmitter.

13. The transmitter according to claim 8, configured for pseudo random noise modulation, by at least one of:
a) a spreading sequence which is not employed by GNSS satellites in the area where said transmitter is deployed;
b) two or more different spreading sequences.

14. The transmitter according to claim 8, attached to a directional antenna, configured to point its main transmission lobe substantially along the line between the actual position of said transmitter and the position of the transmitter as indicated by said reference signals.

15. A Global Navigation Satellite System (GNSS) receiver, for determining self position by detecting reference signals broadcast by at least one transmitter specifying an imaginary orbit in space on which said transmitter is reported to be, said orbit based on an ellipse, one of said ellipse foci at the center of the earth, and at least one point on said orbit substantially stationary in reference to the surface of the earth, said reference signals indicating the position of said transmitter substantially at said stationary point, wherein said receiver configured to detect said reference signals and:
(i) calculate the momentarily position of said transmitter on said imaginary orbit in space;
(ii) estimate the distance to said momentarily position;
(iii) determine self position, upon calculating the position of and estimating the distance to typically four transmitters.

16. The GNSS receiver according to claim 15, wherein said imaginary orbit specifying at least one of:
a) semi-major axis of said ellipse equal to zero, or to the distance between the center of the earth and a specific point on the earth surface, or to the geostationary radius;
b) eccentricity of said ellipse equal to zero;
c) inclination between said orbit and the earth equator equal to zero, or to ninety degrees;
d) rotation speed of said orbit around the earth axis equal to zero, or to the earth rotation speed, or to the earth rotation speed plus or minus the angular speed on an equatorial orbit due to the earth gravitational force;
e) corrected argument of latitude of said transmitter on its orbit substantially constant in time;
f) corrected mean motion of said transmitter on its orbit equal to zero.

17. The GNSS receiver according to claim 15, said orbit rotation speed around the earth axis configured equal to the earth rotation speed, and at least one of:
a) the corrected argument of latitude of said transmitter configured substantially constant in time;
b) the corrected mean motion of said transmitter configured equal to zero;
wherein the position of said transmitter at one specific time instant configured equal to the actual position of said transmitter.

18. The GNSS receiver according to claim 15, said orbit configured polar and circular, stationary over the longitude on which said transmitter is actually located, said orbit radius equal to the distance between the earth center and the actual position of said transmitter, and the corrected argument of latitude of said transmitter equal to the latitude on which said transmitter is actually located.

19. The GNSS receiver according to claim 15, wherein at least one of: the actual transmission time instant or the reported transmission time instant of said reference signals, configured to, at least one of:
a) the actual transmission time of other reference signals;
b) the reported transmission time of other reference signals;
c) the actual transmission time of other reference signals corrected according to the actual position of said transmitter and to the reported position of said transmitter;
d) the reported transmission time of other reference signals corrected according to the actual position of said transmitter and to the reported position of said transmitter.

20. The GNSS receiver according to claim 15, configured to calculate the position of said transmitter applying the Keplerian equations on data broadcast by said transmitter.
